(19) United States
(12) Patent Application Publication
(10) Pub. No.: US 2013/0011769 A1
(43) Pub. Date: Jan. 10, 2013

(54) FUEL CELL SEPARATOR AND FUEL CELL

(75) Inventors: Hiroki Kusakabe, Osaka (JP); Toshihiro Matsumoto, Osaka (JP); Norihiko Kawabata, Osaka (JP); Yoshiki Nagao, Osaka (JP); Shinsuke Takeguchi, Osaka (JP); Yasuo Takebe, Kyoto (JP); Masaki Nobuoka, Nara (JP)

(73) Assignee: Panasonic Corporation, Osaka (JP)

(21) Appl. No.: 13/549,190

(22) Filed: Jul. 13, 2012

Related U.S. Application Data
(62) Division of application No. 12/159,926, filed on Jul. 2, 2008, now abandoned.

(30) Foreign Application Priority Data
Jan. 5, 2006 (JP) 2006-000884

(51) Int. Cl. H01M 2/18

(52) U.S. Cl. 429/508

(57) ABSTRACT

A fuel cell separator having a turn portion of a serpentine-shaped reaction gas passage region. In the turn portion, a recessed portion is defined by an outer end of the turn portion and oblique boundaries between the recessed portion and a pair of passage groove group. In the turn portion, a plurality of protrusions, which vertically extend from a bottom face of the recessed portion and are arranged in an island form, are disposed such that one or more protrusions form a plurality of columns lined up and spaced apart from each other with a gap in a direction in which the outer end extends and one or more protrusions form a plurality of rows lined up and spaced apart from each other with a gap in a direction perpendicular to the direction in which the outer end extends.

### TECHNICAL FIELD

The present invention relates to a fuel cell separator and a fuel cell.

### BACKGROUND ART

A polymer electrolyte fuel cell (hereafter also referred to as “PEFC” as needed) is a heat and electric power supply system which generates electric power and heat simultaneously by causing a fuel gas containing hydrogen and an oxidizing gas containing oxygen such as air to undergo an electrochemical reaction in the fuel cell.

The fuel cell has a membrane electrode assembly, referred to as “MEA.” The MEA is sandwiched between a pair of electrically-conductive separators (specifically, a pair of separators comprising an anode separator and a cathode separator) such that gaskets are disposed on the peripheral portions of both surfaces of the MEA. The PEFC typically has a structure in which MEA units are stacked in plural stages between the pair of electrically-conductive separators.

A serpentine-type fuel gas passage region through which a fuel gas (which is, of the reaction gas, a gas containing a reducing gas supplied to the anode) flows is formed on the surface of the anode separator so as to connect a fuel gas supply passage (fuel gas supply manifold hole) and a fuel gas discharge passage (fuel gas discharge manifold hole). The fuel gas passage region is formed by a plurality of fuel gas passage grooves formed so as to connect the fuel gas supply passage and the fuel gas discharge passage. The plurality of fuel gas passage grooves are bent in a serpentine shape to extend in parallel with each other, and thus the serpentine-type fuel gas passage region is formed.

A serpentine-type oxidizing gas passage region through which an oxidizing gas (which is, of the reaction gas, a gas containing an oxidizing gas supplied to the cathode) flows is formed on the surface of the cathode separator so as to connect an oxidizing gas supply passage (oxidizing gas supply manifold hole) and an oxidizing gas discharge passage (oxidizing gas discharge manifold hole). The oxidizing gas passage region is formed by a plurality of oxidizing gas passage grooves formed so as to connect the oxidizing gas supply passage and the oxidizing gas discharge passage. The plurality of oxidizing gas passage grooves are bent in a serpentine shape to extend in parallel with each other, and thereby the serpentine-type oxidizing gas passage region is formed.

With the above-described configuration, while the fuel gas is flowing through the passage grooves in the fuel gas passage region and while the oxidizing gas is flowing through the passage grooves in the oxidizing gas passage region, these reaction gases (power generation gases) are supplied to the MEA and are consumed by the electrochemical reaction in the interior of the MEA.

In order to put PEFCs into practice, there has been a demand for improvement for realizing a better flow condition of the reaction gases in the anode separator and the cathode separator to enable a more stable electric power generation, and various attempts have been made (see Patent Documents 1 to 4).

For example, a separator provided with a reaction gas flow merge region at a turn portion of a plurality of passage grooves to merge the passage grooves has been proposed, which is intended to sufficiently improve water discharge performance of the condensed water generated in the passage grooves, enhance gas diffusion performance of the reaction gases from the passage grooves to gas diffusion electrodes, reduce passage resistance (pressure loss), and so forth (see, for example, Patent Document 2 and 4). In the flow merge region of the passage grooves, a plurality of protrusions in a dotted form are provided on the bottom surface of a concave portion connected to the plurality of passage grooves.

Also, a separator in which the number of passage grooves changes (reduces) as the passage grooves are closer from reaction gas supply passage (gas inlet side) to the reaction gas discharge passage (gas outlet side) has been proposed, which is aimed at improving the water discharge performance of the condensed water, improving gas diffusion performance, and reducing the size effectively (see, for example, Patent Documents 1 and 3).
Patent Document 1: Japanese Unexamined Patent Publication No. 11-250923
Patent Document 2: Japanese Unexamined Patent Publication No. 10-106594
Patent Document 3: Japanese Unexamined Patent Publication No. 2000-294261
Patent Document 4: Japanese Unexamined Patent Publication No. 2000-164230

### DISCLOSURE OF THE INVENTION

### Problems the Invention is to Solve

Nevertheless, the conventional separators which are represented by the separators disclosed in Patent Documents 1 through 4 are far from an optimum design which well satisfies performance required for the separators, such as reduction in variations of the reaction gas flow rate in the passage grooves, improvement in water discharge performance of condensed water generated inside the passage grooves, improvement in the gas diffusion performance of the reaction gas from the passage grooves to the gas diffusion electrode, reduction in passage resistance (pressure loss) of the passage grooves, and promotion of mixing of the reaction gases. In particular, there has still been room for improvement in the design of the reaction gas flow merge region in which a plurality of passage grooves are merged.

For example, in a turn portion (grid-shaped groove: flow merge region) disclosed in Patent Document 2, grid-shaped grooves are formed over the entire width of a plurality of passage grooves (i.e., across the passage grooves at both ends) for the purpose of improving the promotion of gas mixing of the reaction gases. However, since these grid-shaped grooves are provided so as to form linear boundaries which are perpendicular to the plurality of passage grooves (i.e., to form a quadrilateral flow merge region), the reaction gas may be stagnant in the grid-shaped grooves. Accordingly, the reaction gas distribution state in a plurality of passage grooves which are located downstream of the grid-shaped grooves degrades due to such a stagnant condition of the reaction gases, thereby resulting in non-uniformity in the reaction gas flow rate between the passage grooves.

In particular, when the fuel cell is operated under a low load condition (when the reaction gas flow rate is low), the condensed water tends to concentrate in the vicinity of downstream passages in the direction in which the reaction gas moves. So, the problem that the above-mentioned reaction gases are stagnant is more noticeably observed, causing excess water which inhibits gas diffusion, degrading performance of the fuel cell, which phenomenon (flooding) tends to occur.

In addition, although a substantially triangular flow merge region disclosed in Patent Document 4 is designed to suppress the problem that the reaction gases are stagnant, the design is far from appropriately preventing the clogging (flooding) within the passage grooves with water droplets caused by concentration of condensed water and generated water within the passage grooves, and thus, there has still been room for improvement.

As used herein the term “flooding” refers to the phenomenon of clogging of the interior of the gas passage grooves with water droplets in a separator, which is different from the phenomenon of clogging of the interior of the gas diffusion electrode, for example, the pores which serve as gas diffusion paths within the catalyst layers with water droplets (flooding within the gas diffusion electrodes).

The present invention has been accomplished in view of the foregoing circumstances, and it is an object of the present invention to provide a fuel cell separator and a fuel cell which are capable of appropriately and well suppressing flooding caused by excess condensed water within passage grooves.

### Means for Solving the Problems

To solve the above described problems, the present invention provides a fuel cell separator, wherein the fuel cell separator is formed in a plate shape and is provided on at least one main surface thereof with a reaction gas passage region through which a reaction gas flows, the reaction gas passage region being formed in a serpentine shape having a plurality of uniform-flow portions through which the reaction gas flows in one direction and one or more turn portions provided between the plurality of uniform-flow portions, the reaction gas flowing to turn in the turn portions; wherein

the reaction gas passage region comprises:

a plurality of flow splitting regions being formed so as to include at least the uniform-flow portions, and having a passage groove group for splitting a flow of the reaction gas; and

one or more flow merge regions formed in at least one of the one or more turn portions, the regions having a recessed portion forming a space in which the reaction gas is mixed and a plurality of protrusions which vertically extend from a bottom face of the recessed portion and are arranged in an island form, being disposed between the passage groove group of an adjacent upstream flow splitting region and the passage groove group of an adjacent downstream flow splitting region of the plurality of flow splitting regions, and being configured to allow the reaction gas flowing from the passage groove group of the upstream flow splitting region to merge in the recessed portion and to allow the reaction gas which has been merged to split again and flow into the downstream flow splitting region; and

in the upstream flow splitting region and the downstream flow splitting region which are connected to the recessed portion of the flow merge region, the number of grooves of the passage groove group of the upstream flow splitting region is equal to the number of grooves of the passage groove group of the downstream flow splitting region;

the recessed portion of the flow merge region is, in the turn portion of the reaction gas passage region in which the recessed portion is formed, defined by an outer end of the turn portion and oblique boundaries between the recessed portion and a pair of the upstream passage groove group and the downstream passage groove group which are connected to the recessed portion;

when viewed from a direction substantially normal to the main surface, the plurality of protrusions are disposed such that one or more protrusions form a plurality of columns lined up and spaced apart from each other with a gap in a direction in which the outer end extends and one or more protrusions form a plurality of rows lined up and spaced apart from each other with a gap in a direction perpendicular to the direction in which the outer end extends; and

the plurality of protrusions are configured such that flow of the reaction gas is guided by protrusions forming one row in the direction in which the outer end extends and is disturbed by protrusions forming a row adjacent the one row.

In accordance with the plurality of protrusions disposed in the island form in the recessed portion, the reaction gas flowing from the passage grooves in the flow splitting region into the flow merge region is guided by the protrusions forming one row and is thereafter disturbed in flow by the protrusions forming a row adjacent the one row. This makes it possible to promote mixing of the reaction gas between the passage grooves. As a result, flooding due to excess condensed water within the passage groove located downstream of the recessed portion can be suppressed.

Furthermore, the boundaries between the flow merge region of the reaction gas and the pair of upstream passage groove group and the downstream passage groove group connected to the recessed portion are defined obliquely with respect to the orientations of the passage groove groups. Therefore, the reaction gas flows uniformly within the flow merge region, and the reaction gas distribution performance for the passage grooves located downstream does not degrade. Thus, uniformity in the reaction gas flow rate can be maintained.

To reliably obtain the advantage of the present invention, it is preferable that in the fuel cell separator of the present invention, when viewed from the direction substantially normal to the main surface, the boundary between the recessed portion of the flow merge region and the upstream flow splitting region and the downstream flow splitting region which are connected to the recessed portion forms a shape protruding, in an arc shape, from both ends of a base which is the outer end toward a vertex located in the vicinity of a boundary line between the upstream flow splitting region connected to the recessed portion and the downstream flow splitting region connected to the recessed portion.

By defining the recessed portion so as to be in the shape protruding in the arc shape, the reaction gas can be allowed to flow uniformly over substantially the entire area of the recessed portion (for example, the reaction gas can be sent out to the corners of the recessed portion appropriately). Thus, uniformity in the reaction gas flow rate can be improved (i.e., variations in the reaction gas flow rate can be reduced sufficiently) without degrading the reaction gas distribution performance for the passage grooves located downstream of the recessed portion.

To obtain the advantage of the present invention appropriately, it is preferable that in the fuel cell separator of the present invention, one example of the recessed portion may be such that the shape protruding in an arc shape is substantially triangular.

By defining the recessed portion so as to be in substantially the triangular shape, the reaction gas can be allowed to flow uniformly over substantially the entire area of the recessed portion (for example, the reaction gas can be sent out to the corners of the recessed portion appropriately). Thus, uniformity in the reaction gas flow rate can be improved further (i.e., variations in the reaction gas flow rate can be reduced sufficiently) without degrading the reaction gas distribution performance for the passage grooves located downstream of the recessed portion.

With regard to the substantially triangular shape, each side of the triangle need not be strictly a linear line, as long as the advantageous effects of the present invention can be obtained. For example, it may be a curve protruding in an arc shape outward of the triangle, a curve bent in an arc shape inward of the triangle, or a step-like discontinuous line.

To appropriately obtain the advantage of the present invention, it is preferable that in the fuel cell separator of the present invention, one example of the recessed portion may be such that, the shape protruding in an arc shape is substantially semi-circular.

By defining the recessed portion so as to be in substantially the semi-circular shape as well, the reaction gas can be allowed to flow uniformly over substantially the entire area of the recessed portion (for example, the reaction gas can be sent out to the corners of the recessed portion appropriately). Thus, uniformity in the reaction gas flow rate can be improved further (i.e., variations in the reaction gas flow rate can be reduced sufficiently) without degrading the reaction gas distribution performance for the passage grooves located downstream of the recessed portion.

With regard to the substantially semi-circular shape, it need not be strictly a semi-circle, as long as the advantageous effects of the present invention can be obtained. For example, it may be a semi-ellipsoid shape, and the curved line of the semicircle (or the semi-ellipsoid) may be a step-like discontinuous line other than a curved line.

To improve water discharge performance of water droplets generated within the passage grooves, it is preferable that in the fuel cell separator of the present invention, the flow splitting region is formed to include the uniform-flow portion and the turn portion, and the number of the passage grooves in the uniform-flow portion is equal to the number of passage grooves in the turn portion connected to the uniform-flow portion (see FIGS. 2 and 6 as described later).

By forming such a flow splitting region including the uniform-flow portion and the turn portion, relatively long passage grooves can be formed. In other words, the passage length per one passage groove included in a flow splitting region disposed between two flow merge regions can be made long. With such a passage groove with a long passage length, even when the water droplets are generated in the passage groove, the difference between the gas pressure applied on the upstream side of the water droplets and the gas pressure applied on the downstream side thereof becomes large, and therefore, good water discharge performance can be obtained.

Preferably, the fuel cell separator of the present invention may further comprise a gas inlet manifold configured to supply the reaction gas from outside to the reaction gas passage region; and a gas outlet manifold configured to discharge a gas discharged from the reaction gas passage region to outside; and wherein the uniform-flow portion of the flow splitting region disposed on the most upstream side of the plurality of flow splitting regions may be connected to the gas inlet manifold.

In the above-described configuration, the flow merge region of the present invention is disposed neither immediately after the gas inlet manifold nor immediately before the gas outlet manifold. In this case, it becomes possible to easily prevent a part of the reaction gas from flowing into the gap formed between the outer peripheral edge of the gas diffusion electrode of the MEA and the inner peripheral edge of the annular gasket disposed on the outer side of the MEA when assembling the fuel cell. Moreover, the structure for preventing a part of the reaction gas from flowing into the above-described gap can be made simple.

More specifically, the above-described gap exists between the gas inlet manifold and the reaction gas passage region, and the passage for supplying the reaction gas from the gas inlet manifold to the reaction gas passage region crosses the above-described gap. In addition, the above-described gap also exists between the gas outlet manifold and the reaction gas passage region, and the passage for discharging the reaction gas from the reaction gas passage region to the gas outlet manifold crosses the above-described gap. For this reason, a structure for gas sealing so that the passage for supplying the reaction gas is not connected to the above-described gap is necessary. If there is no such structure for gas sealing, the reaction gas flowing into the above-described gap without being supplied to the reaction gas passage region and flowing into the gas outlet manifold through the above described gap, of the reaction gas supplied from the gas inlet manifold i.e., wasteful gas (gas which is not consumed in the MEA), increases in amount.

Since the flow merge region supports the gas diffusion electrode and the gasket (made of synthetic resin) in contact therewith by the protrusions vertically extended from the recessed portion, there is a possibility that the contact surface of the gasket (made of synthetic resin) may sink into the portion in which there is no protrusions, resulting in an increase in the passage resistance (pressure loss). Accordingly, as with the separators according to patent document 2 and patent document 4 descried previously, when the flow merge region (referred to as “inlet side passage groove portion” in patent documents 2 and 4) is disposed immediately after the gas inlet manifold and the flow merge region (referred to as “outlet side passage groove portion” in patent documents 2 and 4) is disposed immediately before the gas outlet manifold, the structure for gas sealing aiming at preventing the reaction gas from flowing into the above-described gap becomes more complicated, and the formation of the structure becomes difficult.

In contrast, when the flow merge region is not disposed immediately after the gas inlet manifold as described above, the structure for gas sealing aiming at preventing the reaction gas from flowing into the above-described gap can be made more simple, and the structure can be formed easily.

In this case, it is preferable that the uniform-flow portion of the flow splitting region disposed on the most downstream side of the plurality of flow splitting regions is connected to the gas outlet manifold.

In the above-described configuration, the flow merge region of the present invention is disposed neither immediately after the gas inlet manifold nor immediately before the gas outlet manifold. In this case, it becomes possible to easily prevent a part of the fuel gas from flowing into the gap formed between the outer peripheral edge of the gas diffusion electrode of the MEA and the inner peripheral edge of the annular gasket disposed on the outer side of the MEA when assembling the fuel cell. Also, the structure for preventing a part of the reaction gas from flowing into the above-described gap can be made more simple, and the structure can be formed easily.

It should be noted that when the flow merge region is not disposed immediately after the gas inlet manifold (when the turn portion is not disposed immediately after the gas inlet manifold either), one of the flow splitting regions which is disposed on the most downstream side of the plurality of the flow splitting regions may have a turn portion in which no flow merge region is formed, and the turn portion may be connected to the gas outlet manifold. In this case, also, the structure for preventing a part of the reaction gas from flowing into the above-described gap can be made simple, and the structure can be formed easily.

The fuel cell separator of the present invention may further comprise a gas inlet manifold configured to supply the reaction gas from outside to the reaction gas passage region; and a gas outlet manifold configured to discharge a gas discharged from the reaction gas passage region to outside; and wherein a flow splitting region disposed on the most upstream side of the plurality of flow splitting regions may have a turn portion in which the flow merge region is not formed, and the turn portion may be connected to the gas inlet manifold.

In this case, also, the structure for preventing a part of the reaction gas from flowing into the above-described gap can be made simple, and the structure can be formed easily.

Furthermore, when the flow merge region is not disposed immediately after the gas inlet manifold (when a turn portion having no flow merge region is disposed immediately after the gas inlet manifold), it is preferable that the uniform-flow portion of the flow splitting region disposed on the most downstream side of the plurality of the flow splitting regions be connected to the gas outlet manifold.

In this case, also, the structure for preventing a part of the reaction gas from flowing into the above-described gap can be made simple, and the structure can be formed easily.

Furthermore, when the flow merge region is not disposed immediately after the gas inlet manifold (when a turn portion having no flow merge region is disposed immediately after the gas inlet manifold), a flow splitting region disposed on the most downstream side of the plurality of flow splitting regions has the turn portion, and the turn portion may be connected to the gas outlet manifold.

In this case, also, the structure for preventing a part of the reaction gas from flowing into the above-described gap can be made simple, and the structure can be formed easily.

It is preferable that in the fuel cell separator of the present invention, a convex-concave pattern comprising a plurality of concave portions having a uniform width, a uniform pitch, and a uniform level difference and a plurality of convex portions having a uniform width, a uniform pitch, and a uniform level difference in a direction crossing the passage groove group, when viewed from the direction substantially normal to the main surface, may be formed on a surface of the separator corresponding to the flow splitting region, the concave portions are passage grooves of the passage groove group, and the convex portions are ribs for supporting an electrode portion making in contact with the main surface; and the plurality of protrusions are disposed on extended lines of the ribs.

By arranging the plurality of protrusions on extended lines of the ribs, suitably, the reaction gas flowing from the passage grooves in the flow splitting region into the flow merge region is guided substantially uniformly in the gaps (grooves) between the plurality of protrusions and is thereafter disturbed in flow by the protrusions forming a subsequent row.

In the convex-concave pattern configuration, the electrode portion makes contact with the convex portions having the uniform pitch, the uniform width, and the uniform level difference, and as a result, the electrode portion in contact with the main surface can be supported uniformly over the surface. Moreover, the separator having such a convex-concave pattern can be manufactured by die molding. Thereby, the separator can be constructed by a single plate, and as a result, manufacturing cost of the separator can be improved (reduced).

When such a configuration is adopted, the electrode portion (gas diffusion electrode) sinks evenly into the passage grooves (concave portions) provided with a uniform pitch, a uniform width, and a uniform level difference. As a result, when the reaction gas is flowed through the passage grooves, non-uniformity (variations) in the passage resistance (pressure loss) of the reaction gas between the passage grooves can be suppressed sufficiently.

It is preferable that in the fuel separator of the present invention, when viewed from the direction substantially normal to the main surface and when a virtual line is drawn to pass through a center in a gap between a pair of protrusions arranged adjacent each other to form one row and to extend in parallel to the direction in which the outer end extends, a center in a gap between a pair of protrusions which are adjacent the former pair of protrusions in the direction in which the outer end extends deviates from the virtual line in the direction perpendicular to the direction in which the outer end extends.

By arranging the plurality of protrusions such that the center in the gap between a pair of protrusions deviate from the virtual line in the manner described above, the gas-liquid two-phase flow is prevented from easily passing through the gap between the protrusions and make contact with the protrusions appropriately plural times so that the flow thereof is disturbed while flowing in the recessed portion in the direction in which the outer end extends. This makes it possible to reliably suppress the flooding due to excess condensed water within the fuel gas passage grooves located downstream of the recessed portion.

It is preferable that particularly when the protrusions are arranged to deviate in the above described above, each of the columns is formed by protrusions constituting every other row.

In the separator in which a plurality of protrusions are disposed in the recessed portion in such a manner that the lines connecting the centers of the protrusions in the adjacent columns to each other are bent in a V-shape plural times, that is, in what is called a zigzag array configuration, the condensed water is dispersed appropriately and allowed to flow into passage grooves located downstream of the recessed portion. Thereby, it becomes possible to reliably prevent the flooding due to the excess condensed water in the passage grooves located downstream of the recessed portion.

In the fuel cell separator of the present invention, the shape of the protrusions may be any shape as long as the advantages of the present invention can be achieved. For example, the protrusions may have one shape selected from a substantially cylindrical shape, a substantially triangular prism shape, and a substantially quadrangular prism shape.

As used herein, the term “substantially cylindrical shape” is meant to include a shape in which the cross section perpendicular to the direction in which the protrusions extend vertically has a substantially right circular cylindrical shape as well as one in which the cross section deviates from the right circular shape (for example, an elliptic shape).

As used herein, the term “substantially triangular prism shape in the present specification is a prism shape in which the cross section perpendicular to the direction in which the protrusions extend is shaped into a triangular shape formed of three points which are not in the same linear line and three line segments connecting the three points (such as a right triangle, an isosceles triangle, or an equilateral triangle), and it is also meant to include prism shapes in which the angles at the three corners are slightly round.

Furthermore, the term “substantially quadrangular prism shape” is a prism shape in which the cross section perpendicular to the direction in which the protrusions extend is shaped into a quadrilateral shape formed of four points which are not in the same linear line and four line segments connecting them (such as a rectangle, a square, a parallelogram, or a trapezoid), and it is also meant to include prism shapes in which the angles at the four corners are slightly round.

As used herein, the above-described array pattern of the protrusions in which “each of the columns is formed by the protrusions constituting every other row” is referred to as a “zigzag array.”

It is preferable that in the fuel cell separator of the present invention, one suitable example of the zigzag array in the recessed portion may be such that when the protrusions are formed in the substantially cylindrical shape, the protrusions are disposed to be spaced apart from each other in each row with a gap which is substantially equal to a diameter of a circular cross-section of each protrusion, and are disposed to be spaced apart from each other in each column with a gap which is substantially three times as large as the diameter of the circular cross-section of each protrusion. This is suitable because the protrusions are disposed regularly in a zigzag array configuration over the surface of the recessed portion, which contributes to effectively achieving uniform distribution of the condensed water between the passage grooves (lessening of non-uniform distribution).

In the fuel cell separator of the present invention, first protrusions and second protrusions having different width dimensions in the direction in which the outer end extends and/or in the direction perpendicular to the direction in which the outer end extends may be disposed so as to form a plurality of rows lined up and spaced apart from each other with a gap in the direction perpendicular to the direction in which the outer end extends.

By disposing the first protrusions and the second protrusions having different width dimensions in the direction in which the outer end extends or the direction perpendicular to the direction in which the outer end extends in this way, the lines connecting the centers in the gaps between the first protrusions and the second protrusions in the direction in which the outer end extends or the direction perpendicular to the direction in which the outer end extends are bent in a longitudinal direction of the gaps in which the gas-liquid two-phase flow flows. As a result, when the gas-liquid two-phase flows through the gaps in the recessed portion in the direction in which the outer end extends or the direction perpendicular to the direction in which the outer end extends, the flow of the gas-liquid two-phase flow is bent and disturbed so that it is prevented from easily passing through the gaps.

Therefore, mixing of the reaction gas is promoted by such a bent flow of the reaction gas. In addition, the flooding due to the excess condensed water in the fuel gas passage grooves located downstream is suppressed because of the bent flow of the condensed water.

Furthermore, the reaction gas passage resistance within the recessed portion can be adjusted so that the reaction gas flow rate can become uniform by appropriately adjusting the numbers and arrangement locations of such bent portions for each of the columns and rows.

It should be noted that the shapes of the first protrusions and the second protrusions may be any shapes as long as the advantages of the present invention can be achieved. For example, the protrusions may have one shape selected from a substantially cylindrical shape, a substantially triangular prism shape, and a substantially quadrangular prism shape as described above.

The present invention provides a fuel cell separator of the present invention, wherein the fuel cell separator is formed in a plate shape and is provided on at least one main surface thereof with a reaction gas passage region through which a reaction gas flows, the reaction gas passage region being formed in a serpentine shape having a plurality of uniform-flow portions through which the reaction gas flows in one direction and one or more turn portions provided between the plurality of uniform-flow portions, the reaction gas flowing to turn in the turn portions; wherein

the reaction gas passage region comprises:

a plurality of flow splitting regions being formed so as to include at least the uniform-flow portions, and having a passage groove group for splitting a flow of the reaction gas; and

one or more flow merge regions formed in at least one of the one or more turn portions, the regions having a recessed portion forming a space in which the reaction gas is mixed and a plurality of protrusions which vertically extend from a bottom face of the recessed portion and are arranged in an island form, being disposed between the passage groove group of an adjacent upstream flow splitting region and the passage groove group of an adjacent downstream flow splitting region of the plurality of flow splitting regions, and being configured to allow the reaction gas flowing from the passage groove group of the upstream flow splitting region to merge in the recessed portion and to allow the reaction gas which has been merged to split again and flow into the downstream flow splitting region; and

in the upstream flow splitting region and the downstream flow splitting region which are connected to the recessed portion of the flow merge region, the number of grooves of the passage groove group of the upstream flow splitting region is equal to the number of grooves of the passage groove group of the downstream flow splitting region;

the recessed portion of the flow merge region is, in the turn portion of the reaction gas passage region in which the recessed portion is formed, defined by an outer end of the turn portion and oblique boundaries between the recessed portion and a pair of the upstream passage groove group and the downstream passage groove group which are connected to the recessed portion;

when viewed from a direction substantially normal to the main surface, the outer end is curved to form in intermediate locations outer end protruding portions protruding toward the recessed portion.

In the separator formed with the outer end protruding portions in the recessed portion, the condensed water is properly dispersed in the passage grooves located downstream of the recessed portion. This makes it possible to sufficiently suppress the occurrence of the flooding due to excess condensed water within the passage grooves located downstream of the recessed portion.

It is preferable that in the fuel cell separator of the present invention, a convex-concave pattern comprising a plurality of concave portions having a uniform width, a uniform pitch, and a uniform level difference and a plurality of convex portions having a uniform width, a uniform pitch, and a uniform level difference in a direction crossing the passage groove group, is formed on a surface of the separator corresponding to the flow splitting region when viewed from the direction substantially normal to the main surface; the concave portions are passage grooves of the passage groove group, and the convex portions are ribs for supporting an electrode portion making in contact with the main surface; and the plurality of protrusions are disposed on extended lines of the ribs.

By arranging the plurality of protrusions on extended lines of the ribs, suitably, the reaction gas flowing from the passage grooves in the flow splitting region into the flow merge region is guided substantially uniformly in the gaps (grooves) between the plurality of protrusions and is thereafter disturbed in flow by the protrusions forming a subsequent row.

In the convex-concave pattern configuration, the electrode portion makes contact with the convex portions having the uniform pitch, the uniform width, and the uniform level difference, and as a result, the electrode portion in contact with the main surface can be supported uniformly over the surface. Moreover, the separator having such a convex-concave pattern can be manufactured by die molding. Thereby, the separator can be constructed by a single plate, and as a result, manufacturing cost of the separator can be improved (reduced).

Also, the electrode portion (gas diffusion electrode) sinks evenly into the passage grooves (concave portions) provided with a uniform pitch, a uniform width, and a uniform level difference. As a result, when the reaction gas is flowed through the passage grooves, non-uniformity (variations) in the passage resistance (pressure loss) of the reaction gas between the passage grooves can be suppressed sufficiently.

It is preferable that in the fuel cell separator of the present invention, a first distance between the protrusion and the rib, between the protrusion and the outer end protruding portion, and between the rib and the outer end may be smaller than a second distance between the protrusions. Such a configuration is particularly referable when the protrusions are formed in the substantially cylindrical shape.

Since the first distance is set narrower than the second distance, uniformization of the flow rate distribution of the reaction gas flowing in the recessed portion over the entire surface can be adjusted more appropriately by the passage resistance effected by such distances.

In brief, to appropriately obtain the advantage of the present invention, it is preferable that in the fuel cell separator of the present invention, the first distance and the second distance are set in such a manner that a product of the first distance and a flow rate of the reaction gas flowing across the first distance assuming that the first distance and the second distance are constant substantially matches a product of the second distance and a flow rate of the reaction gas flowing across the second distance assuming that the first distance and the second distance are constant.

To appropriately obtain the advantage of the present invention, the features of the present invention “the plurality of protrusions are disposed such that one or more of the protrusions form a plurality of columns lined up and spaced apart from each other with a gap in the direction in which the outer end extends and one or more of the protrusions form a plurality of rows lined up and spaced apart from each other with a gap in the direction perpendicular to the direction in which the outer end extends, and each of the columns is formed by protrusions forming every other row.” are added to the invention including the features “the outer end is desirably curved in intermediate locations to include outer end protruding portions protruding toward the recessed portion, and the improved invention thereof. This may be an optimal design for suppressing the flooding due to excess condensed water within the passage grooves located downstream of the recessed portion.

The present invention provides a fuel cell comprising:

an anode separator, a cathode separator, and a membrane electrode assembly disposed between the anode separator and the cathode separator; and comprising:

one or more stack units each including said anode separator, said membrane electrode assembly, and said cathode separator;

the above described fuel cell separator of the present invention is incorporated as the anode separator and the cathode separator; and

the reaction gas supplied to the anode separator is a reducing gas, and the reaction gas supplied to the cathode separator is an oxidizing gas.

With such a configuration, the reducing gas which flows through the flow splitting region in the anode separator diffuses in a good condition substantially uniformly within the electrode portion on the anode separator side over almost the entire area of the anode separator surface because the reducing gas consumption is taken into consideration and the flooding due to the excess condensed water in the passage grooves is suppressed. In addition, the oxidizing gas which flows through the flow splitting region in the cathode separator diffuses in a good condition substantially uniformly within the electrode portion on the cathode separator side over almost the entire area of the cathode separator surface because the oxidizing gas consumption is taken into consideration and the flooding due to the excess condensed water in the passage grooves is suppressed. As a result, the power generating operation by the fuel cell is carried out nearly uniformly over almost the entire area of the electrode portion.

The foregoing and other objects, features and advantages of the present invention will become more readily apparent from the following detailed description of preferred embodiments of the invention, with reference to the accompanying drawings.

### Effects of the Invention

As should be appreciated from the foregoing, in accordance with the present invention, a fuel cell separator and a fuel cell which are capable of appropriately and sufficiently suppressing flooding due to excess condensed water within passage grooves.

### BRIEF DESCRIPTION OF THE DRAWINGS

FIG. 1 is an exploded perspective view schematically showing a structure of a fuel cell according to one embodiment of the present invention.

FIG. 2 is a view showing a surface of an anode separator.

FIG. 3 is a cross-sectional view of the anode separator taken along line in FIG. 2.

FIG. 4 is a cross-sectional view of the anode separator taken along line IV-IV in FIG. 2.

FIG. 5 is an enlarged view of a region C in FIG. 2.

FIG. 6 is a view showing a surface of a cathode separator.

FIG. 7 is a cross-sectional view of the cathode separator taken along line VII-VII in FIG. 6.

FIG. 8 is a cross-sectional view of the cathode separator taken along line VIII-VIII in FIG. 6.

FIG. 9 is an enlarged view of the C region in FIG. 6.

FIG. 10 is a plan view of a structure of an analysis model according to a comparative example;

FIG. 11 is a view simulating an example of an analysis result output onto a computer, based on flow data of elements of an analysis model according to the comparative example;

FIG. 12 is a view simulating an example of an analysis result output onto a computer, based on flow data of elements according to an analysis model according to the embodiment;

FIG. 13 is a plan view showing a structure of a passage turn adjacent portion according to a first modification example;

FIG. 14 is a plan view showing a structure of a passage turn adjacent portion according to a second modification example;

FIG. 15 is a plan view showing a structure of a passage turn adjacent portion according to a third modification example;

FIG. 16 is a plan view showing a structure of a passage turn adjacent portion according to a fourth modification example; and

FIG. 17 s a plan view showing a structure of a passage turn adjacent portion according to a fifth modification example.

### BRIEF DESCRIPTION OF THE REFERENCE NUMERALS

| | |
|---|---|
| 1 | MEA |
| 2 | anode separator |
| 3 | cathode separator |
| 4 | bolt hole |
| 5 | electrode portion |
| 6 | polymer electrolyte membrane |
| 6a | peripheral portion |
| 10 | fuel cell |
| 12A, 12B | fuel gas manifold hole |
| 13A, 13B | oxidizing gas manifold hole |
| 14A, 14B | water manifold hole |
| 21 | fuel gas flow splitting region set |
| 21A | 1st fuel gas flow splitting region |
| 21B | 2nd fuel gas flow splitting region |
| 21C | 3rd fuel gas flow splitting region |
| 21D | 4th fuel gas flow splitting region |
| 22 | fuel gas flow merge region set |
| 22A | 1st fuel gas flow merge region |
| 22B | 2nd fuel gas flow merge region |
| 22C | 3rd fuel gas flow merge region |
| 25 | fuel gas passage groove (concave portion) |
| 26, 36 | convex portion |
| 27, 37 | cylindrical protrusion |
| 28, 38 | recessed portion |
| 28a, 38a | base |
| 28b, 28c, 38b, 38c | hypotenuse |
| 31 | oxidizing gas flow splitting region set |
| 31A | 1st oxidizing gas flow splitting region |
| 31B | 2nd oxidizing gas flow splitting region |
| 31C | 3rd oxidizing gas flow splitting region |
| 31D | 4th oxidizing gas flow splitting region |
| 31E | 5th oxidizing gas flow splitting region |
| 32 | oxidizing gas flow merge region set |
| 32A | 1st oxidizing gas flow merge region |
| 32B | 2nd oxidizing gas flow merge region |
| 32C | 3rd oxidizing gas flow merge region |
| 32D | 4th oxidizing gas flow merge region |
| 35 | oxidizing gas passage groove (concave portion) |
| 40 | end plate |
| 100 | fuel cell stack |
| 101 | fuel gas passage region |
| 102 | oxidizing gas passage region |
| 201, 202 | region |
| 601, 701 | turn portion |
| 602, 702 | linear portion (uniform-flow portion) |
| P1, P2, P3, P4 | pitch |
| D1, D2, D3, D4 | level difference |
| W1, W2, W3, W4 | width |

### BEST MODE FOR CARRYING OUT THE INVENTION

Hereinbelow, preferred embodiments of the present invention will be described with reference to the drawings.

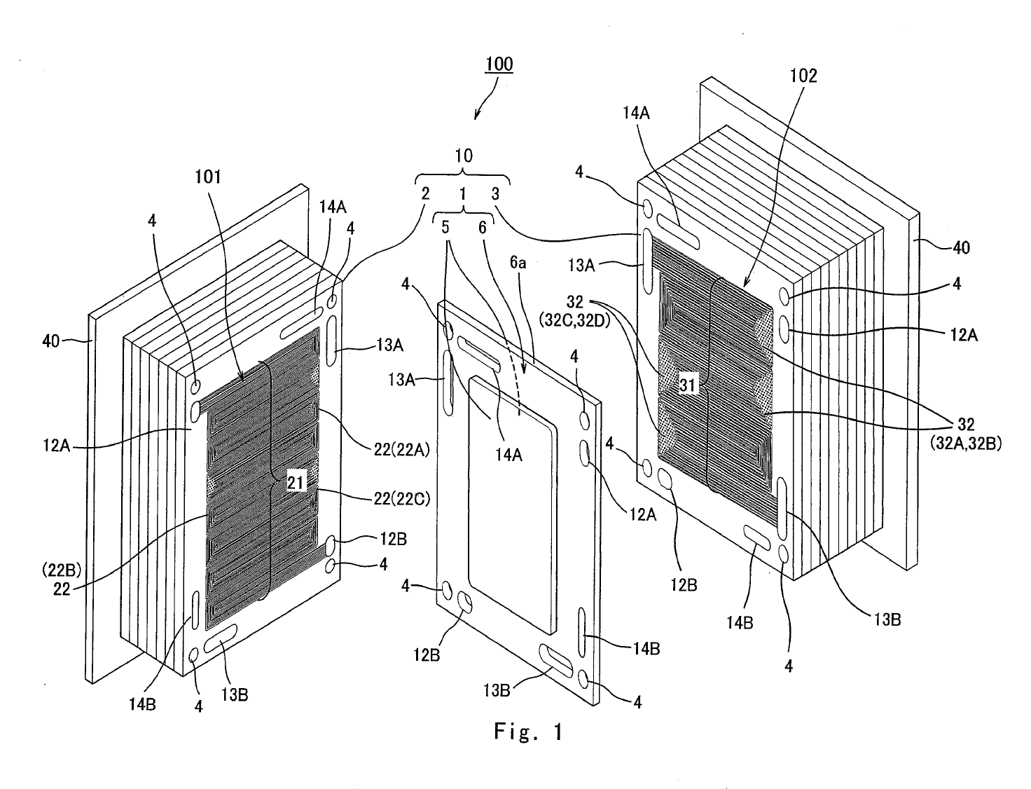

FIG. 1 is an exploded perspective view schematically showing a structure of a fuel cell according to an embodiment of the present invention.

As shown in FIG. 1, a fuel cell stack 100 is formed by stacking a plurality of rectangular fuel cells 10.

End plates 40 are attached to the outermost layers at both ends of the fuel cell stack 100, and the fuel cells 10 are fastened by fastening bolts (not shown) which are inserted into bolt holes 4 at the four corners of the fuel cells 10 from both of the end plates 40 and nuts (not shown). Here, for example, 60 cells of the fuel cells 10 are stacked.

A MEA 1 of the fuel cell 10 comprises a pair of rectangular electrode portions 5 (a catalyst layer and a gas diffusion layer) provided at a central portion of both surfaces of a polymer electrolyte membrane 6. The fuel cell 10 has a pair of plate-shaped electrically-conductive separators 2 and 3. Rectangular and annular gaskets (not shown) are provided on a peripheral portion 6a of the MEA 1. The gaskets and the electrode portions 5 of the MEA 1 are sandwiched between the pair of electrically-conductive separators (specifically, an anode separator 2 and a cathode separator 3). Since the structure of the MEA 1 is known, the detailed description thereof will be omitted here.

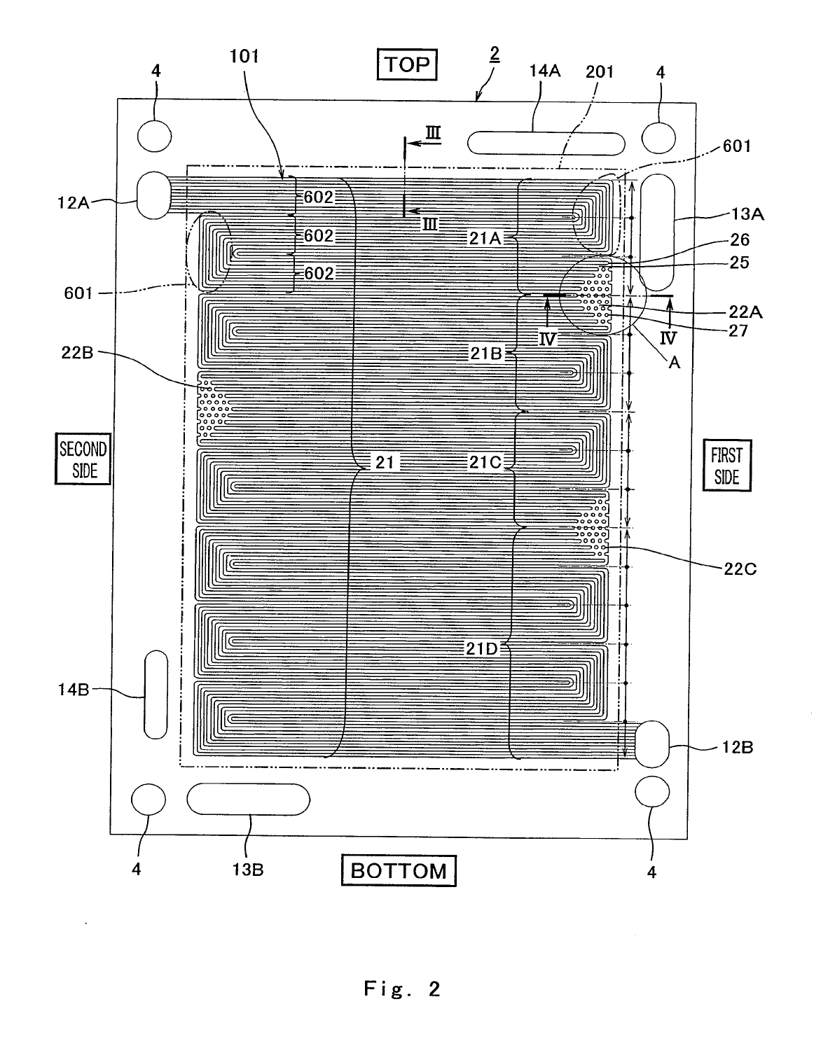

A fuel gas passage region 101 through which a fuel gas (reducing gas) flows is formed on a surface (obverse surface; a contact surface in contact with one of the electrode portions 5) of the anode separator 2. This fuel gas passage region 101 comprises a fuel gas flow splitting region set 21 having a plurality of belt-shaped fuel gas passage grooves 25 (passage groove group: see, for example, FIG. 2), for distributing the fuel gas as uniformly as possible and causing it to flow at a flow rate which is as uniform as possible, and a fuel gas flow merge region set 22 having a plurality of protrusions 27 (see, for example, FIG. 2) in an island form (in a substantially cylindrical form, more precisely, a substantially right circular cylindrical form herein) for merging the plurality of fuel gas passage grooves 25 to promote mixing of the fuel gas. Whereas the protrusions 27 of the present embodiment are formed in a substantially cylindrical shape, as shown in FIG. 2, the shape of the protrusions 27 is not limited to this, and the protrusions 27 may be formed in at least one shape selected from a substantially cylindrical shape, a substantially triangular prism shape, and a substantially quadrangular prism shape. It is to be understood that even when the cross-section perpendicular to the direction in which the protrusions 27 vertically extend has an elliptic cylinder shape, as will be described in later-described modified example 2, other than the substantially right circular cylindrical shape of the present embodiment, such protrusions are regarded as having a substantially cylindrical shape herein. The configuration of the fuel gas passage region 101 will be described in detail later.

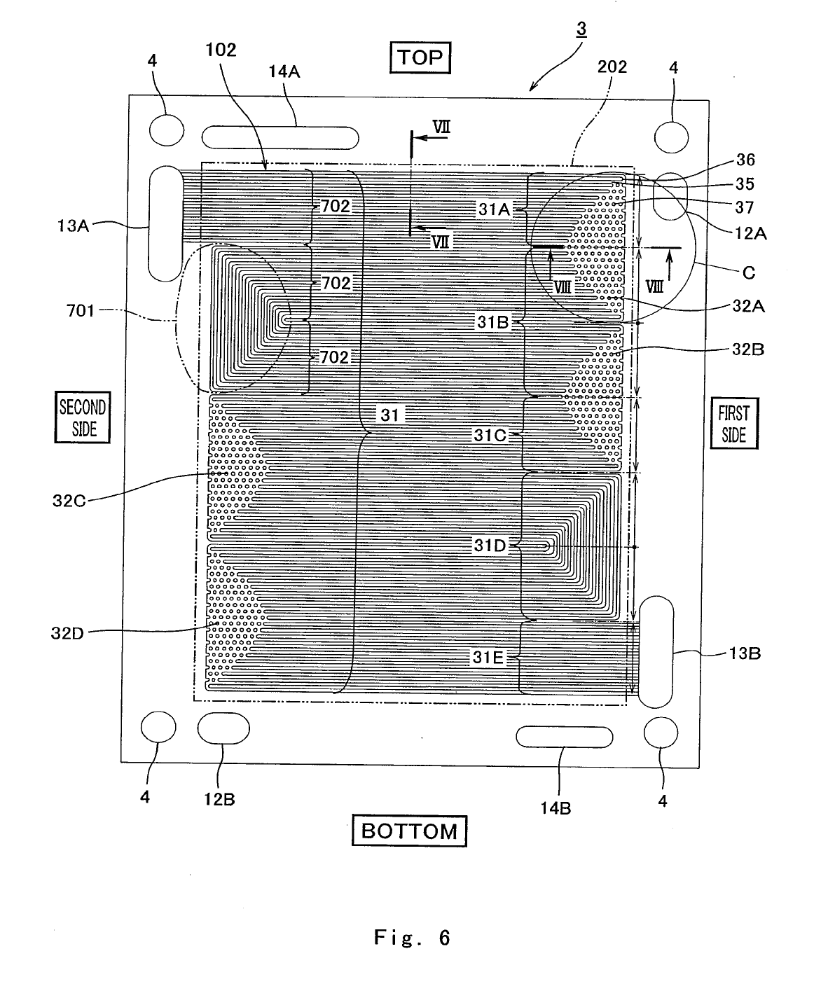

An oxidizing gas passage region 102 through which an oxidizing gas flows is formed on a surface (obverse surface; a contact surface in contact with the other one of the electrode portions 5) of the cathode separator 3. This oxidizing gas passage region 102 comprises an oxidizing gas flow splitting region set 31 having a plurality of belt-shaped oxidizing gas passage grooves 35 (passage groove group: see, for example, FIG. 6), for distributing the oxidizing gas as uniformly as possible and causing it to flow at a flow rate which is as uniform as possible, and an oxidizing gas flow merge region set 32 having a plurality of protrusions 37 (see, for example, FIG. 6) in an island form (in a substantially cylindrical form, more precisely, a substantially right circular cylindrical form herein) for merging a plurality of the oxidizing gas passage grooves 35 to promote mixing of the oxidizing gas. Whereas the protrusions 37 of the present embodiment are formed in a substantially cylindrical shape like the foregoing protrusions 27, as shown in FIG. 6, the shape of the protrusions 37 is not limited to this, and the protrusions 37 may be formed in at least one shape selected from a substantially cylindrical shape, a substantially triangular prism shape, and a substantially quadrangular prism shape. The configuration of the oxidizing gas passage region 102 will be described in detail later.

A pair of fuel gas manifold holes 12A and 12B for supplying and discharging the fuel gas, a pair of oxidizing gas manifold holes 13A and 13B for supplying and discharging the oxidizing gas, and cooling water manifold holes 14A and 14B for supplying and discharging cooling water are provided in the separators 2 and 3 and the peripheral portion 6a of the MEA 1 so as to penetrate therethrough.

In the configuration in which the fuel cells 10 are stacked, these holes 12A, 12B, 13A, 13B, 14A, 14B, and so forth are connected continuously so that a pair of elliptic cylinder shaped fuel gas manifolds, a pair of elliptic cylinder shaped oxidizing gas manifolds, and a pair of elliptic cylinder shaped cooling water manifolds are formed to extend in a direction (threaded member fastening direction) in which the components are stacked to form the fuel cell stack 100.

The fuel gas passage region 101 is formed so as to extend in a serpentine shape and in a belt shape and to connect the fuel gas manifold hole 12A and the fuel gas manifold hole 12B. Thereby, a part of the fuel gas flowing through the fuel gas manifold is guided from the fuel gas manifold hole 12A of each anode separator 2 to the fuel gas passage region 101. The fuel gas guided in this way is consumed as a reaction gas in the MEA 1 while flowing through the fuel gas passage region 101. The fuel gas which remains unconsumed flows out from the fuel gas passage region 101 to the fuel gas manifold hole 12B of each anode separator 2, flows through the fuel gas manifold, and is discharged outside the fuel cell stack 100.

Meanwhile, the oxidizing gas passage region 102 is formed so as to extend in a serpentine shape and in a belt shape and to connect the oxidizing gas manifold hole 13A and the oxidizing gas manifold hole 13B. Thereby, a part of the oxidizing gas flowing through the oxidizing gas manifold is guided from the oxidizing gas manifold hole 13A of each cathode separator 3 to the oxidizing gas passage region 102. The oxidizing gas guided in this way is consumed as a reaction gas in the MEA 1 while flowing through the oxidizing gas passage region 102. The oxidizing gas which remains unconsumed flows out from the oxidizing gas passage region 102 to the oxidizing gas manifold hole 13B of each cathode separator 3, flows through the oxidizing gas manifold, and is discharged outside the fuel cell stack 100.

Cooling water for keeping the fuel cells 10 at an appropriate temperature flows in a plurality of cooling water grooves (not shown) provided on a reverse surface (the opposite surface to the obverse surface) of the cathode separator 3 through a pair of cooling water manifolds. The detailed description of the structure for flowing the cooling water will be omitted herein.

Next, the structure of the fuel gas passage region 101 provided in the anode separator 2 will be described in detail with reference to the drawings.

FIG. 2 is a view showing a surface of the anode separator.

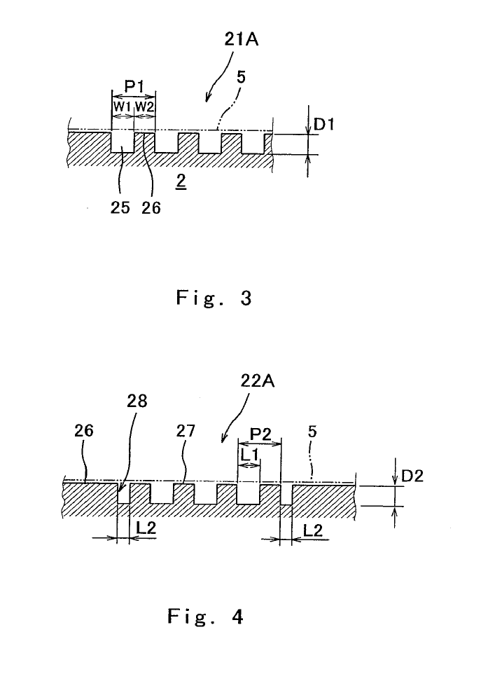

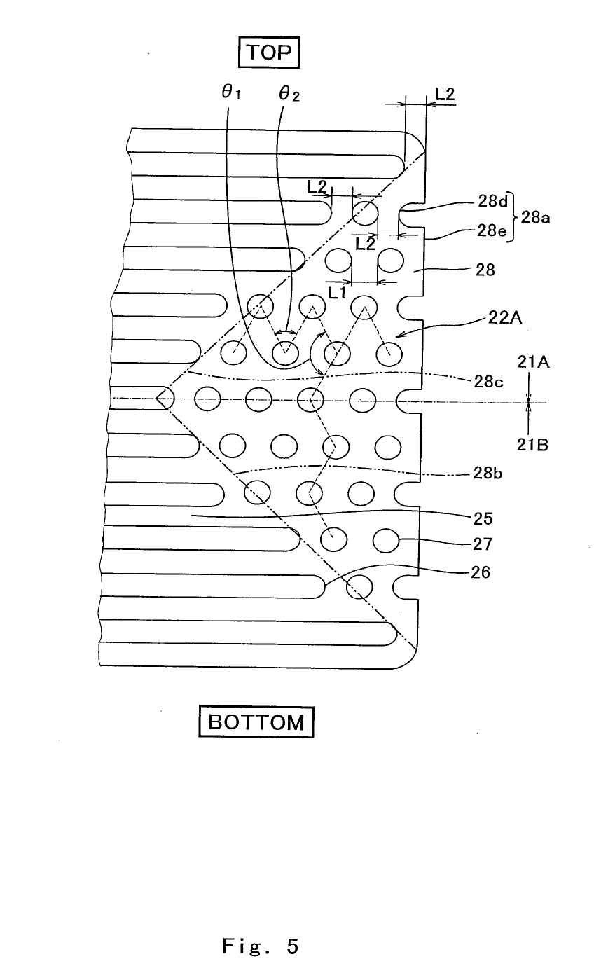

FIG. 3 is a cross-sectional view of the anode separator taken along line in FIG. 2. FIG. 4 is a cross-sectional view of the anode separator taken along line Iv-Iv in FIG. 2. FIG. 5 is an enlarged view of a region Ain FIG. 2.

In FIGS. 2 and 5, the terms “top” and “bottom” refer to the upward direction and the downward direction, respectively, in an installation condition of the fuel cell stack 100 into which the anode separator 2 is incorporated, and in FIG. 2, the terms “first side” and “second side” refer to the rightward or leftward direction and the leftward or rightward direction, respectively, in the installation condition of the fuel cell stack 100 into which the anode separator 2 is incorporated.

As can be seen from FIG. 2, the fuel gas passage region 101 comprises the fuel gas flow splitting region set 21 and the fuel gas flow merge region set 22 (see FIG. 1), which are formed in a serpentine shape in a region 201 of the surface of the anode separator 2 which is in contact with the electrode portion 5 of the MEA 1.

The fuel gas flow splitting region set 21 includes 1st, 2nd, 3rd, and 4th fuel gas flow splitting regions 21A, 21B, 21C, and 21D, in this order from top to bottom.

The fuel gas flow merge region set 22 includes a 1st fuel gas flow merge region 22A interposed between the 1st fuel gas flow splitting region 21A and the 2nd fuel gas flow splitting region 21B, a 2nd fuel gas flow merge region 22B (intermediate flow merge region) interposed between the 2nd fuel gas flow splitting region 21B and the 3rd fuel gas flow splitting region 21C, and a 3rd fuel gas flow merge region 22C interposed between the 3rd fuel gas flow splitting region 21C and the 4th fuel gas flow splitting region 21D.

As shown in FIG. 2, the 1st fuel gas flow splitting region 21A is formed by combining three uniform-flow portions 602 where the reaction gas flows in one direction (where the reaction gas flows in a straight-line shape and hereinafter these portions are referred to as linear portions 602), and two turn portions 601 where the reaction gas turns, of the serpentine-shaped fuel gas passage grooves 25. The 1st fuel gas flow splitting region 21A is formed in such a manner that fuel gas passage grooves 25 in the linear portion 602 are continuous with the fuel gas passage grooves 25 in the turn portion 601 so that the number of fuel gas passage grooves 25 in the linear portion 602 is equal to the number of fuel gas passage grooves 25 in the turn portion 601 connected to that linear portion 602.

Likewise, each of the 2nd fuel gas flow splitting region 21B and the 3rd fuel gas flow splitting region 21C is formed by combining three linear portions (not shown with reference numeral) and two turn portions (not shown with reference numeral). The 2nd fuel gas flow splitting region 21B is also formed in such a manner that fuel gas passage grooves 25 in the linear portion are continuous with the fuel gas passage grooves 25 in the turn portion so that the number of fuel gas passage grooves 25 in the linear portion is equal to the number of fuel gas passage grooves 25 in the turn portion connected to that linear portion. The 3rd fuel gas flow splitting region 21C is also formed in such a manner that the fuel gas passage grooves 25 in the linear portion are continuous with the fuel gas passage grooves 25 in the turn portion so that the number of fuel gas passage grooves 25 in the linear portion is equal to the number of fuel gas passage grooves 25 in the turn portion connected to that linear portion.

Moreover, the 4th fuel gas flow splitting region 21D is formed by combining six linear portions (not shown with reference numeral) and five turn portions (not shown with reference numeral). This 4th fuel gas flow splitting region 21D is also formed in such a manner that the fuel gas passage grooves 25 in the linear portion are continuous with the fuel gas passage grooves 25 in the turn portion so that the number of the fuel gas passage grooves 25 in the linear portion is equal to the number of fuel gas passage grooves 25 in the turn portion connected to that linear portion.

The 1st fuel gas flow merge region 22A is formed in a turn portion interposed between the 1st fuel gas flow splitting region 21A and the 2nd fuel gas flow splitting region 21B. The 2nd fuel gas flow merge region 22B is formed in a turn portion interposed between the 2nd fuel gas flow splitting region 21B and the 3rd fuel gas flow splitting region 21C. Further, the 3rd fuel gas flow merge region 22C is formed in a turn portion interposed between the 3rd fuel gas flow splitting region 21C and the 4th fuel gas flow splitting region 21D.

By forming the flow splitting regions (the 1st, 2nd, 3rd and 4th fuel gas flow splitting regions 21A, 21B, 21C, and 21D) including linear portions and turn portions in this way, relatively long fuel gas passage grooves 25 can be formed, as described previously. In other words, the passage length of every one fuel gas passage groove 25 included in a flow splitting region disposed between two flow merge regions can be made long. With the fuel gas passage grooves 25 with a long passage length, even when water droplets are generated in the fuel gas passage grooves 25, the difference between the gas pressure applied on the upstream side of the water droplets and the gas pressure applied on the downstream side thereof becomes large, and therefore, good water discharge performance can be achieved.

As shown in FIG. 2, a linear portion 602 of the 1st fuel gas flow splitting region 21A, which is disposed on the most upstream side of the four flow splitting regions, is connected to the fuel gas manifold hole 12A (gas inlet manifold), while a linear portion of the 4th flow splitting region 21D, which is disposed on the most downstream side of the four flow splitting regions, is connected to the fuel gas manifold hole 12B (gas outlet manifold).

In other words, the present embodiment employs a configuration in which the flow merge region is disposed neither immediately after the fuel gas manifold hole 12A (gas inlet manifold) nor immediately before the fuel gas manifold hole 12B (gas outlet manifold). As described previously, by employing this configuration, it becomes possible to easily prevent a part of the fuel gas from flowing into the gap (not shown) formed between the outer peripheral edge of the electrode portion 5 (gas diffusion electrode, anode) of the MEA 1 and the inner peripheral edge of the annular gasket disposed on the outer side of the MEA 1 when assembling the fuel cell stack 10. Thus, the structure of the gas seal for preventing the fuel gas from flowing into the just-mentioned gap can be made simpler, and the structure can be easily formed.

When the flow merge region is not disposed immediately after the fuel gas manifold hole 12A (gas inlet manifold) in this way [when the turn portion is not disposed immediately after the fuel gas manifold hole 12A (gas inlet manifold) either], the 4th flow splitting region 21D, which is disposed on the most downstream side of the four flow splitting regions, may have a turn portion (not shown) in which no flow merge region is formed, and the turn portion may be connected to the fuel gas manifold hole 12B (gas outlet manifold). In this case, also, the structure for preventing a part of the reaction gas from flowing into the above-described gap can be made simple, and the structure can be formed easily. In the manner described above, the fuel gas flow splitting region set 21 is divided into the 1st, 2nd, 3rd, and 4th fuel gas flow splitting regions 21A, 21B, 21C, and 21D such that the 1st, 2nd, and 3rd fuel gas flow merge regions 22A, 22B, and 22C are interposed respectively therebetween.

In this embodiment, as shown in FIG. 2, the 2nd fuel gas flow splitting region 21B, which is located downstream of the 1st fuel gas flow merge region 22A, is configured so as to turn the 1st fuel gas flow splitting region 21A on the upstream side with the 1st fuel gas flow merge region 22A interposed therebetween, but the fuel gas flow merge region is not provided for all the turn portions located on both end portions.

In other words, in the anode separator 2, there exist turn portions each comprising a fuel gas flow merge region in which a plurality of protrusions 27 are formed in a recessed portion (described later) and turn portions each comprising a plurality of fuel gas passage grooves 25 bent in a U-shape so that the flow rate of the fuel gas flowing through the fuel gas passage grooves 25 is made uniform to be suitable for discharging of the condensed water.

More specifically, in the present embodiment, in the 1st fuel gas flow splitting region 21A, 6 rows of the fuel gas passage grooves 25 are configured to extend from the fuel gas manifold hole 12A on the 2nd side toward the 1st side, turn 180 degrees at two locations, and reach the 1st fuel gas flow merge region 22A.

In the 2nd fuel gas flow splitting region 21B, 6 rows of the fuel gas passage grooves 25 are configured to extend from the downstream side of the 1st fuel gas flow merge region 22A located at a turn portion on the 1st side toward the 2nd side, turn 180 degrees at two locations, and reach the 2nd fuel gas flow merge region 22B.

In the 3rd fuel gas flow splitting region 21C, 6 rows of the fuel gas passage grooves 25 are configured to extend from the downstream side of the 2nd fuel gas flow merge region 22B located at a turn portion on the 2nd side toward the 1st side, turn 180 degrees at two locations, and reach the 3rd fuel gas flow merge region 22C.

In the 4th fuel gas flow splitting region 21D, 6 rows of the fuel gas passage grooves 25 are configured to extend from the downstream side of the 3rd fuel gas flow merge region 22C located at a turn portion on the 1st side toward the 2nd side, turn 180 degrees at five locations, and reach the fuel gas manifold hole 12B.

As shown in FIG. 3, the transverse cross section of the 1st fuel gas flow splitting region 21A is formed such that a convex-concave pattern comprising a plurality of concave portions 25 (six concave portions herein) and a plurality of convex portions 26 (five convex portions herein) having a uniform pitch P1, a uniform width W1 and W2, and a uniform level difference D1. The concave portions 25 correspond to the fuel gas passage grooves 25 and the convex portions 26 correspond to ribs (support portions for the electrode portion 5) that make contact with and support the electrode portion 5.

In accordance with such a cross-sectional structure of the anode separator 2, the electrode portion 5 of the MEA 1 makes contact with the convex portions 26 of the 1st fuel gas flow splitting region 21A, and thereby is supported uniformly by top faces of the convex portions 26 provided so as to have a uniform pitch P1, a uniform width W2, and a uniform level difference D1. Moreover, the electrode portion 5 sinks evenly into the fuel gas passage grooves 25 provided so as to have a uniform pitch P1, a uniform width W1, and a uniform level difference D1.

This is suitable since such a configuration can well suppress the non-uniformity in the pressure loss of the fuel gas between a plurality of fuel gas passage grooves 25 when the fuel gas is flowed through the fuel gas passage grooves 25 of the 1st fuel gas flow splitting region 21A. Moreover, this is suitable because the non-uniformity of the fuel gas diffusion over the surface (i.e., across the direction perpendicular to the thickness direction of the electrode portion 5) in the electrode portion 5 can be well suppressed.

The anode separator 2 having the above described convex-concave pattern can be manufactured through die molding. This enables the anode separator 2 to be constructed of a single plate. As a result, manufacturing cost of the anode separator 2 can be improved (reduced).

The configurations of the transverse cross-sections of the 2nd, 3rd, and 4th fuel gas flow splitting regions 21B, 21C, and 21D are the same as the configuration described here, and therefore will not be further described.

As can be seen from FIGS. 4 and 5, the 1st fuel gas flow merge region 22A comprises a recessed portion 28 (concave region) which is connected to the fuel gas passage grooves 25 (concave portions 25) and a plurality of protrusions 27 which are arranged in an island form (in a substantially cylindrical form herein) so as to vertically extend from the bottom surface of the recessed portion 28.

As shown in FIG. 2, a recessed portion (not shown with reference numeral) similar to the recessed portion 28 and protrusions (not shown with reference numeral) similar to the protrusions 27 are formed in the 2nd fuel gas flow merge region 22B and the 3rd fuel gas flow merge region 22C. The configurations of the 2nd fuel gas flow merge region 22B and the 3rd fuel gas flow merge region 22C are the same as that of the 1st fuel gas flow merge region 22A, and will not be further described.

The recessed portion 28 is formed on the surface of the anode separator 2 so as to be located in a turn portion on the 1st side of the serpentine-shaped fuel gas passage region 101. The recessed portion 28 is formed in a substantially right triangular shape having a base 28a extending vertically and a pair of hypotenuses 28b and 28c having about 45-degree included angles with the base 28a when viewed from the surface of the anode separator 2. The base 28a forms the outer end (wall surface) of the turn portion of the fuel gas passage region 101, the upper hypotenuse 28b forms the boundary with the 1st fuel gas flow splitting region 21A, and the lower hypotenuse 28c forms the boundary with the 2nd fuel gas flow splitting region 21B.

The base 28a is partially curved so that a plurality of (five) protruding portions 28d (outer end protruding portions) protruding toward the recessed portion 28 and linear base portions 28e interposed between the protruding portions 28d are formed in intermediate locations thereof. Each of the fuel gas passage grooves 25 of the 1st fuel gas flow splitting region 21A is connected to the recessed portion 28 at the upper hypotenuse 28b, while each of the fuel gas passage grooves 25 of the 2nd fuel gas flow splitting region 21B is connected to the recessed portion 28 at the lower hypotenuse 28c. Herein the recessed portion 28 is formed to have the same depth as that of the fuel gas passage grooves 25.

As shown in FIGS. 4 and 5, the plurality of cylindrical protrusions 27 are formed at a uniform pitch P2 on the extended lines of each of the convex portions 26 (except for the uppermost and lowermost ones of the convex portions 26) of the 1st and 2nd fuel gas sub-splitting passages 21A and 21B. The pitch P2 herein is the same as the pitch P1 of the convex portions 26 of each of the fuel gas flow splitting regions 21A and 21B. Moreover, as shown in FIG. 4, all cylindrical protrusions 27 have an even height (level difference) D2 and the same shape.

By arranging the plurality of cylindrical protrusions 27 on the extended lines of the convex portions 26, suitably, the reaction gas flows from each fuel gas passage groove 25A in the 1st fuel gas flow splitting region 21A into the 1st fuel gas merge region 22A such that the reaction gas is guided so as to be dispersed substantially uniformly in the gaps (grooves) between the plurality of cylindrical protrusions 27, and thereafter the flow of the reaction gas moving downward by its own weight is suitably disordered by the cylindrical protrusions 27 forming a subsequent row. In the present embodiment, as shown in FIG. 5, the cylindrical protrusions 27 are arranged so that their centers conform to the direction of the extended lines of the convex portions 26.

The cylindrical protrusions 27 are arranged regularly in so-called zigzag shape as shown in FIG. 5.

To be specific, the plurality of the protrusions 27 are so formed to be lined up at a uniform pitch in a direction in which the base 28a extends (i.e., vertical direction) and be lined up at a uniform pitch in a direction perpendicular to the direction in which the base 28a extends (i.e., horizontal direction). Hereinbelow, a continuum of the cylindrical protrusions 27 in the vertical direction (including the case of only one protrusion) is referred to as a “column,” and the continuum of the cylindrical protrusions 27 in the horizontal direction is referred to as a “row” (including the case of only one protrusion). Accordingly, the plurality of cylindrical protrusions 27 are formed to have 8 columns (respectively referred to as the 1st column through the 8th column in that order from the vertex of the recessed portion 28) and 9 rows (respectively referred to as the 1st row through the 9th row in that order from the top). Each column comprises the cylindrical protrusions 27 which constitute every other row. Conversely, each row comprises the cylindrical protrusions 27 which constitute every other column. In other words, in adjacent columns, the positions of the cylindrical protrusions 27 in the direction in which the columns extends (vertical direction) deviate by half a pitch from each other. Likewise, in adjacent rows, the positions of the cylindrical protrusions 27 in the direction in which the rows extends (horizontal direction) deviate by half a pitch from each other. In each row, the cylindrical protrusions 27 are disposed at a pitch which is twice as long as its diameter thereof (i.e., spaced with a gap equal to its diameter), and in each column, the cylindrical protrusions 27 are disposed at a pitch which is four times as long as its diameter (i.e., spaced with a gap equal to three times as large as its diameter).

Thus, the lines connecting the centers of the cylindrical protrusions 27 in the adjacent columns with each other, or the lines connecting the centers of the cylindrical protrusions 27 in the adjacent rows with each other, extend in such a manner as to be bent in a V-shape in the vertical direction along the base 28a, or in a horizontal direction on the extended line of the convex portions 26.

For example, the lines connecting the centers of the cylindrical protrusions 27 in adjacent columns with each other in the vertical direction (see the dotted lines in FIG. 5) extend in zigzag shape so as to be bent at an obtuse angle (θ₁ shown in FIG. 5 being about 127 degrees) plural times, while the lines connecting the centers of the cylindrical protrusions 27 in adjacent rows with each other in the horizontal direction (see the dotted lines in FIG. 5) extend in zigzag shape so as to be bent at an acute angle (θ₂ shown in FIG. 5 being about 53 degrees) plural times.

As should be understood from the illustration in FIG. 5 and the foregoing description, the zigzag array of the protrusions in the present specification is an array pattern of the cylindrical protrusions 27 in which the columns extending vertically in parallel are constituted by the cylindrical protrusions 27 which constitute every other row (in other words, an array pattern of the cylindrical protrusions 27 in which the rows extending horizontally in parallel are constituted by the cylindrical protrusions 27 which constitute every other column). For example, the zigzag array refers to, regarding the arrangement of the cylindrical protrusions 27 in the vertical direction, a pattern in which the cylindrical protrusions 27 are arranged in zigzag shape between the columns adjacent to each other to enable the gas-liquid two-phase flow flowing through the gaps between the protrusions 27 in a certain row downwardly to contact the protrusions 27 in a subsequent row, in order to avoid that this gas-liquid two-phase flow passes through in the subsequent row without being disturbed at all.

Accordingly, the array pattern as shown in the present embodiment (FIG. 5) in which the cylindrical protrusions 27 in the adjacent columns deviate by half the pitch of the protrusions 27 in the same rows is a typical example of the zigzag array of the cylindrical protrusions 27, but the zigzag array is not limited to this. For example, the gap between the cylindrical protrusions in adjacent columns may be ¼ the pitch of the cylindrical protrusions in the same rows, as will be described later in modified example 5. That is, the array patterns of the cylindrical protrusions in which “the gap between the cylindrical protrusions in the adjacent columns<half the pitch of the cylindrical protrusions in the same rows” or “the gap between the cylindrical protrusions in the adjacent columns>half the pitch of the cylindrical protrusions in the same rows” are also included in the zigzag array of the protrusions in the present specification, so long as the flooding is effectively suppressed.

As shown in FIGS. 4 and 5, the one cylindrical protrusion 27 in the uppermost row (1st row) and one cylindrical protrusion 27 in the lowermost row (9th row) are each located between the convex portion 26 and the protruding portion 28d in such a manner that the cylindrical protrusion 27 in the uppermost row is spaced a distance L2 apart from the convex portion 26 in the 2nd row and from the protruding portion 28d and the cylindrical protrusion 27 in the lowermost row is spaced the distance L2 apart from the convex portion 26 in the 10th row and from the protruding portion 28d.

Two cylindrical protrusions 27 in the 2nd row and two cylindrical protrusions 27 in the 8th row are arranged in the horizontal direction and are located to be spaced a distance L1 apart from each other between the convex portion 26 and the base portion 28e in such a manner that the cylindrical protrusions 27 in the 2nd row are spaced the distance

L2 apart from the convex portion 26 in the 3rd row and from the base portion 28e and the cylindrical protrusions 27 in the 8th row are spaced the distance L2 apart from the convex portion 26 in the 9th row and from the base portion 28e.

Three cylindrical protrusions 27 in the 3rd row and three cylindrical protrusions 27 in the 7th row are arranged in the horizontal direction and are located to be spaced the distance L1 apart from each other between the convex portion 26 and the protruding portion 28d in such a manner that the cylindrical protrusions 27 in the 3rd row is spaced the distance L2 apart from the convex portion 26 in the 4th row and from the protruding portion 28d and the cylindrical protrusions 27 in the 7th row are spaced the distance L2 apart from the convex portion 26 in the 8th row and from the protruding portion 28d.

Four cylindrical protrusions 27 in the 4th row and four cylindrical protrusions 27 in the 6th row are arranged in the horizontal direction and are located to be spaced the distance L1 apart from each other between the convex portion 26 and the base portion 28e in such a manner that the cylindrical protrusions 27 in the 4th row are spaced the distance L2 apart from the convex portion 26 in the 5th row and from the base portion 28e and the cylindrical protrusions 27 in the 6th row are spaced the distance L2 apart from the convex portion 26 in the 7th row and from the base portion 28e.

Four cylindrical protrusions 27 in the 5th row are arranged in the horizontal direction and are located to be spaced the distance L1 apart from each other between the convex portion 26 and the protruding portion 28d in such a manner that the cylindrical protrusions 27 are spaced the distance L2 apart from the convex portion 26 in the 6th row and from the protruding portion 28d.

The cylindrical protrusion 27 is not present between the convex portion 26 in the uppermost row (1st row) and the base portion 28e and between the convex portion 26 in the lowermost row (11th row) and the base portion 28e. The convex portions 26 are spaced the distance L2 apart from the base portions 28e.

It has been found through the later-described fluid analysis simulation that the flow rate of the reaction gas is higher in the gaps between the cylindrical protrusion 27 and the convex portion 26, between the cylindrical protrusion 27 and the protruding portion 28d, and between the convex portion 26 and the protruding portion 28d than in the gap between the cylindrical protrusions 27. For this reason, the distance L2 between the cylindrical protrusion 27 and the convex portion 26, between the cylindrical protrusion 27 and the protruding portion 28d, and between the convex portion 26 and the protruding portion 28d are made narrower than the distance L1 between the cylindrical protrusions 27, as shown in FIGS. 4 and 5.

A specific design guideline for the distances L1 and L2 is as follows. The distance L1 and the distance L2 are set in such a manner that the product of the distance L1 and the flow rate of the reaction gas flowing across the distance L1 assuming that the distance L1 and the distance L2 are equal will substantially match the product of the distance L2 and the flow rate of the reaction gas flowing across the distance L2 assuming that the distance L1 and the distance L2 are equal. By making the distance L2 between the cylindrical protrusion 27 and the convex portion 26, between the cylindrical protrusion 27 and the protruding portion 28d, and between the convex portion 26 and the protruding portion 28d narrower than the distance L1 between the cylindrical protrusions 27, uniformization of the flow rate distribution of the fuel gas and the condensed water flowing in the recessed portion 28 over the entire surface can be appropriately adjusted by the passage resistance exhibited by the distance L2.

In the manner described above, the cylindrical protrusions 27 serve as the gas flow disturbing portions for promoting mixing of the fuel gas and also serve as the support portions (ribs) for the electrode portion 5 of the MEA 1.

The configurations of the 2nd and 3rd fuel gas flow merge regions 22B and 22C are the same as the configuration described here, and therefore the descriptions of the configurations thereof will be omitted.

The above described anode separator 2 (particularly the configuration of the fuel gas flow merge regions) makes it possible to obtain the following advantages regarding promotion of fuel gas mixing, suppressing flooding due to excess condensed water, and fuel gas pressure uniformization between a plurality of fuel gas passage grooves 25.

Firstly, since the 1st, 2nd, and 3rd fuel gas flow merge regions 22A, 22B, and 22C are formed so as to have oblique linear boundaries with the fuel gas flow splitting regions, and the distances L1 or L2 between the cylindrical protrusion 27, and the convex portion 26, the protruding portion 28d, and the base portion 28e are properly set, the fuel gas flows uniformly in the 1st fuel gas flow merge region 22, for example, and the fuel gas distribution performance for the fuel gas passage grooves 25 located downstream thereof (the fuel gas passage grooves 25 of the 2nd fuel gas flow splitting region 21B) does not degrade, making it possible to keep the uniformity of fuel gas flow rate in a good condition (in a condition in which variation of the gas flow rate can be reduced sufficiently).

Secondly, since the 1st, 2nd, and 3rd fuel gas flow merge regions 22A, 22B, and 22C are defined in a shape protruding in an arc shape as described above, more specifically, in a substantially triangular shape, the fuel gas can be allowed to flow substantially over the entire area of the recessed portion so that it can be sent out appropriately to the corners of the recessed portion 28. Therefore, the fuel gas distribution performance for the fuel gas passage grooves 25 located downstream of the recessed portion 28 does not degrade, and thus the uniformity in the fuel gas flow rate can be improved (i.e., variation in the gas flow rate can be reduced sufficiently).

Thirdly, the flow of the fuel gas and the flow of the condensed water flowing from the fuel gas passage grooves 25 of the fuel gas flow splitting region set 21 into the fuel gas flow merge region set 22 are disturbed by the plurality of cylindrical protrusions 27 arranged in the zigzag shape in the recessed portion 28. Thereby, the mixing of the fuel gas and condensed water between the fuel gas passage grooves 25 can be promoted, and the flooding due to the excess condensed water within the passage grooves can be suppressed appropriately. The effect of suppressing the flooding is supported by a calculation result of a fluid simulation described later.

Fourthly, since the base 28a of the recessed portion 28 is curved to form in intermediate positions the plurality of (five) protruding portions 28d (outer end protruding portions) protruding toward the recessed portion 28 and linear base portions 28e each sandwiched between these protruding portions 28d, a part of the fuel gas and the condensed water flowing from each fuel gas passage groove 25 of the fuel gas flow splitting region set 22 into the fuel gas flow merge region set 22, which part flows in the vicinity of the base (outer end) 28a, is disturbed in flow. This makes it possible to promotion of mixing of the fuel gas and the condensed water between the fuel gas passage grooves 25, and to thus appropriately suppress the flooding due to the excess condensed water within the passage grooves. The effect of suppressing the flooding is supported by a calculation result of a fluid simulation described later.

Fifthly, all the fuel gas passage grooves 25 of the fuel gas flow splitting region set 22 are gathered in the fuel gas flow merge region set 22, and here, pressure uniformization of the fuel gas is achieved.

In the present embodiment, the number of grooves of the fuel gas passage grooves 25 in the fuel gas flow splitting regions 21A, 21B, 21C, and 21D is set equal (sixth row). In an alternative example of the present embodiment, it becomes possible to finely adjust the numbers of grooves of the fuel gas passage grooves 25 in the fuel gas flow merge regions 22A, 22B, and 22C, which serve as the relay parts which can change the number of grooves as desired. For example, the number of grooves of the fuel gas flow splitting regions located upstream of the fuel gas flow merge regions 22A, 22B, and 22C may be one row smaller than the number of grooves of the fuel gas passage grooves in the fuel gas flow splitting regions located downstream of the fuel gas flow merge regions 22A, 22B, and 22C. This suitably enables fine adjustment of the flow rate of the fuel gas, considering a fuel gas consumption amount of the fuel gas flowing in the fuel gas passage grooves 25.

Next, the structure of the oxidizing gas passage region 102 provided in the cathode separator 3 will be described in detail with reference to the drawings.

FIG. 6 is a view showing a surface of the cathode separator.

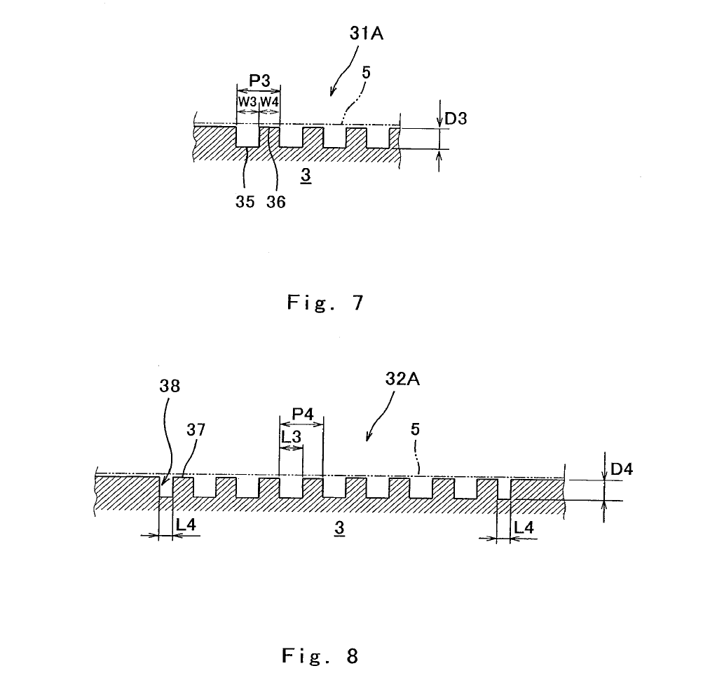

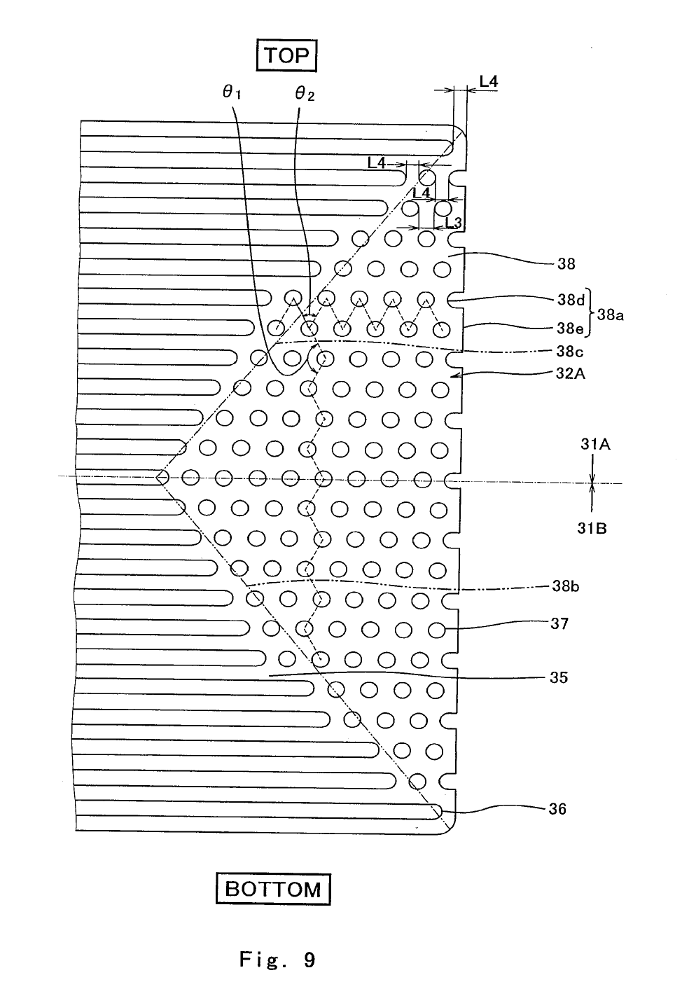

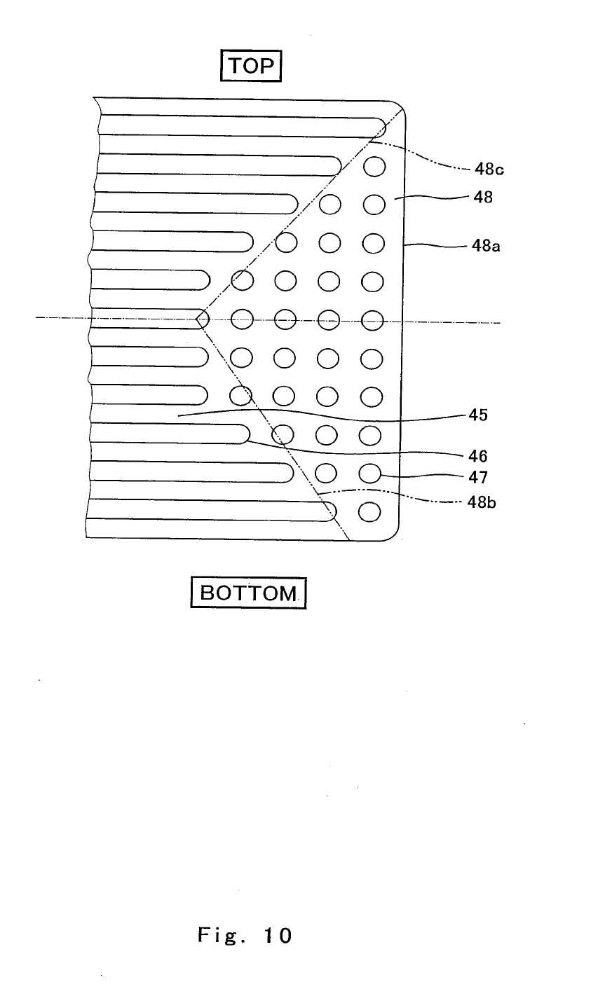

FIG. 7 is a cross-sectional view of the cathode separator taken along line VII-VII in FIG. 6. FIG. 8 is a cross-sectional view of the cathode separator taken along line VIII-VIII in FIG. 6. FIG. 9 is an enlarged view of a region C in FIG. 6.

In FIGS. 6 and 9, the terms “top” and “bottom” refer to the upward direction and the downward direction, respectively, in an installation condition of the fuel cell stack 100 in which the cathode separator 3 is incorporated, and in FIG. 6, the terms “first side” and “second side” refer to the rightward or leftward direction and the leftward or rightward direction, respectively, in the installation condition of the fuel cell stack 100 in which the cathode separator 3 is incorporated.

As can be seen from FIG. 6, the oxidizing gas passage region 102 comprises an oxidizing gas flow splitting region set 31 and an oxidizing gas flow merge region set 32, which are formed in a serpentine shape in a region 202 of the surface of the cathode separator 3 which is in contact with the electrode portion 5 of the MEA 1.

The oxidizing gas flow splitting region set 31 comprises 1st, 2nd, 3rd, 4th, and 5th oxidizing gas flow splitting regions 31A, 31B, 31C, 31D and 31E, defined in that order from top to bottom.

The oxidizing gas flow merge region set 32 include a 1st oxidizing gas flow merge region 32A interposed between the 1st oxidizing gas flow splitting region 31A and the 2nd oxidizing gas flow splitting region 31B, a 2nd oxidizing gas flow merge region 32B (intermediate flow merge region) interposed between the 2nd oxidizing gas flow splitting region 31B and the 3rd oxidizing gas flow splitting region 31C, a 3rd oxidizing gas flow merge region 32C (intermediate flow merge region) interposed between the 3rd oxidizing gas flow splitting region 31C and the 4th oxidizing gas flow splitting region 31D, and a 4th oxidizing gas flow merge region 32D interposed between the 4th oxidizing gas flow splitting region 31D and the 5th oxidizing gas flow splitting region 31E.

As shown in FIG. 6, the 1st oxidizing gas flow splitting region 31A is formed by one uniform-flow portion 702 in which the reaction gas flows in one direction (hereinafter referred as linear portion 702 where the reaction gas flows in straight-line shape) of the serpentine-shaped oxidizing gas passage grooves 35. Likewise, the 3rd oxidizing gas flow splitting region 31C is also formed by one linear portion (not shown with the reference numerals). Further, a 5th oxidizing gas flow splitting region 31E is also formed by one linear portion (not shown with the reference numerals) of the serpentine-shaped oxidizing gas passage grooves 35.

The 2nd oxidizing gas flow splitting region 31B is formed by combining two linear portions 702 and one turn portion 701 where the reaction gas turns, of the serpentine-shaped oxidizing gas passage grooves 35. This 2nd oxidizing gas flow splitting region 31B is formed such that the oxidizing gas passage groove 35 in the linear portion 702 are continuous with the oxidizing gas passage grooves 35 in the turn portion 701 so that the number of oxidizing gas passage grooves 35 in the linear portions 702 is equal to the number of oxidizing gas passage grooves 35 in the turn portion 701 connected to that linear portion 702.

Likewise, the 4th oxidizing gas flow splitting region 31D is formed by combining two linear portions (not shown using reference numeral) and one turn portion (not shown using reference numeral). This 4th oxidizing gas flow splitting region 31D is also formed such that the oxidizing gas passage grooves 35 in the linear portion 702 are continuous with the oxidizing gas passage grooves 35 in the turn portion 701 so that the number of the oxidizing gas passage grooves 35 in the linear portion is equal to the number of the oxidizing gas passage grooves in the turn portion connected to that linear portion.

The 1st oxidizing gas flow merge region 32A is formed in a turn portion interposed between the 1st oxidizing gas flow splitting region 31A and the 2nd oxidizing gas flow splitting region 31B. The 2nd oxidizing gas flow merge region 32B is formed in a turn portion interposed between the 2nd oxidizing gas flow splitting region 31B and the 3rd oxidizing gas flow splitting region 31C. Further, the 3rd oxidizing gas flow merge region 32C is formed in a turn portion interposed between the 3rd oxidizing gas flow splitting region 31C and the 4th oxidizing gas flow splitting region 31D. Moreover, the 4th oxidizing gas flow merge region 32D is formed in a turn portion interposed between the 4th oxidizing gas flow splitting region 31D and the 5th oxidizing gas flow splitting region 31E.

By forming the flow splitting regions (the 2nd and 4th oxidizing gas flow splitting regions 31B and 31D) including the linear portions and the turn portions in this way, relatively long passage grooves 35 can be formed, as already discussed previously. In other words, the passage length of each oxidizing gas passage groove 35 included in a flow splitting region disposed between two flow merge regions can be made long. Even when water droplets are generated in the oxidizing gas passage grooves 35, the oxidizing gas passage grooves 35 with such a long passage length, makes larger the difference between the gas pressure applied on the upstream side of the water droplets and the gas pressure applied on the downstream side thereof. Therefore, good water discharge performance can be obtained.

As shown in FIG. 2, a linear portion 702 of the 1st oxidizing gas flow splitting region 31A, which is disposed on the most upstream side of the five flow splitting regions, is connected to the oxidizing gas manifold hole 13A (gas inlet manifold), and a linear portion of the 5th flow splitting region 31E, which is disposed on the most downstream side of the five flow splitting regions, is connected to the oxidizing gas manifold hole 13B (gas inlet manifold).

In other words, the present embodiment employs a configuration in which the flow merge region is disposed neither immediately after the oxidizing gas manifold hole 13A (gas inlet manifold) nor immediately before the oxidizing gas manifold hole 13B (gas outlet manifold). As already mentioned previously, by employing this configuration, it becomes possible to easily prevent a part of the oxidizing gas from flowing into the gap (not shown) formed between the outer peripheral edge of the electrode portion 5 (gas diffusion electrode, cathode) of the MEA 1 and the inner peripheral edge of the annular gasket disposed on the outer side of the MEA 1 when assembling the fuel cell stack 10. Thereby, the structure of the gas seal for preventing the oxidizing gas from flowing into the gap can be made simpler, and the structure can be easily formed.

When the flow merge region is not disposed immediately after the oxidizing gas manifold hole 13A (gas inlet manifold) in this way [when the turn portion is not disposed immediately after the oxidizing gas manifold hole 13A (gas inlet manifold) either], the 5th flow splitting region 31E, which is disposed on the most downstream side of the five flow splitting regions, may have a turn portion (not shown) in which no flow merge region is formed, and the turn portion may be connected to the oxidizing gas manifold hole 13B (gas outlet manifold). In this case, also, the structure for preventing a part of the reaction gas from flowing into the above-described gap can be made simple, and the structure can be formed easily.

In the manner as described above, the oxidizing gas flow splitting region set 31 is divided into the 1st, 2nd, 3rd, 4th and 5th oxidizing gas flow splitting regions 31A, 31B, 31C, 31D and 31E such that the 1st, 2nd, 3rd, and 4th oxidizing gas flow merge regions 32A, 32B, 32C, and 32D are interposed therebetween.

In the present embodiment, as shown in FIG. 6, the 2nd oxidizing gas flow splitting region 31B, which is located downstream of the 1st oxidizing gas flow merge region 32A, is configured so as to turn the 1st oxidizing gas flow splitting region 31A on the upstream side with the 1st oxidizing gas flow merge region 32A interposed therebetween. The oxidizing gas flow merge region is not provided for all the turn portions located on both side end portions.

In other words, in the cathode separator 3, there exist turn portions comprising oxidizing gas flow merge regions in which a plurality of cylindrical protrusions 37 are formed in a recessed portion (described later) and turn portions comprising a plurality of oxidizing gas passage grooves 35 bent in a U-shape so that the flow rate of the oxidizing gas flowing in the oxidizing gas passage grooves 35 is made uniform to be suitable for discharging of the condensed water.

More specifically, in the present embodiment, in the 1st oxidizing gas flow splitting region 31A, 11 rows of the oxidizing gas passage grooves 35 are configured to extend from the oxidizing gas manifold hole 13A on the 2nd side toward the 1st side and to reach the 1st oxidizing gas flow merge region 32A.

In the 2nd oxidizing gas flow splitting region 31B, 11 rows of the oxidizing gas passage grooves 35 are configured to extend from the downstream side of the 1st oxidizing gas flow merge region 32A located at a turn portion on the 1st side toward the 2nd side, to turn 180 degrees at one location, and to reach the 2nd oxidizing gas flow merge region 32B.

In the 3rd oxidizing gas flow splitting region 31C, 11 rows of the oxidizing gas passage grooves 35 are configured to extend from the downstream side of the 2nd oxidizing gas flow merge region 32B located at a turn portion on the 1st side toward the 2nd side and to reach the 3rd oxidizing gas flow merge region 32C.

In the 4th oxidizing gas flow splitting region 31D, 11 rows of the oxidizing gas passage grooves 35 are configured to extend from the downstream side of the 3rd oxidizing gas flow merge region 32C located at a turn portion on the 2nd side toward the 1st side, to turn 180 degrees at one location, and to reach the 4th oxidizing gas flow merge region 32D.

In the 5th oxidizing gas flow splitting region 31E, 11 rows of the oxidizing gas passage grooves 35 are configured to extend from downstream side of the 3rd oxidizing gas flow merge region 32D located at a turn portion on the 2nd side toward theist side and to reach the oxidizing gas manifold hole 13B.

As shown in FIG. 7, the transverse cross section of the 1st oxidizing gas flow splitting region 31A is such that a convex-concave pattern is formed to include a plurality of concave portions 35 (eleven concave portions herein) and a plurality of convex portions 36 (ten convex portions herein), having a uniform pitch P2, a uniform width W3 and W4, and a uniform level difference D3. The concave portions 35 correspond to the oxidizing gas passage grooves 35 and the convex portions 36 correspond to ribs (support portions for the electrode portion 5) which make contact with and support the electrode portion 5.

With such a cross-sectional structure of the cathode separator 3, the electrode portion 5 of the MEA 1 makes contact with the convex portions 36 of the 1st oxidizing gas flow splitting region 31A, and thereby is supported uniformly by top faces of the convex portions 36 provided so as to have a uniform pitch P3, a uniform width W4, and a uniform level difference D3. Moreover, the electrode portion 5 sinks evenly into the oxidizing gas passage grooves 35 provided so as to have a uniform pitch P3, a uniform width W3, and a uniform level difference D3.

This is suitable since such a configuration sufficiently suppress the non-uniformity in the pressure loss of the oxidizing gas between a plurality of oxidizing gas passage grooves 35 when flowing the oxidizing gas through the oxidizing gas passage grooves 35 of the 1st oxidizing gas flow splitting region 31A. Also, such a configuration is suitable because the non-uniformity of the oxidizing gas diffusion over the surface (i.e., in the direction perpendicular to the thickness direction of the electrode portion 5) in the electrode portion 5 can be suppressed sufficiently.

The cathode separator 3 having the above described convex-concave pattern can be manufactured through die molding. This enables the cathode separator 3 to be constructed of a single plate. As a result, a manufacturing cost of the cathode separator 3 can be improved (reduced).

The configurations of the transverse cross sections of the 2nd, 3rd, 4th, and 5th oxidizing gas flow splitting regions 31B, 31C, 31D, and 31E are the same as the configuration described here, and therefore will not be further described.

As can be seen from FIGS. 8 and 9, the 1st oxidizing gas flow merge region 32A comprises a recessed portion 38 (concave-shaped region) which is connected to the oxidizing gas passage grooves 35 (concave portions 35) and a plurality of cylindrical protrusions 37 in an island form which vertically extend from the bottom face of the recessed portion 38.

As shown in FIG. 6, a recessed portion (not shown with reference numeral) similar to the recessed portion 38 and protrusions (not shown with reference numeral) similar to the protrusions 37 are formed in the 2nd oxidizing gas flow merge region 32B, the 3rd oxidizing gas flow merge region 32C, and the 4th oxidizing gas flow merge region 32D. The configurations of the 2nd oxidizing gas flow merge region 32B, the 3rd oxidizing gas flow merge region 32C, and the 4th oxidizing gas flow merge region 32D are the same as that of the 1st oxidizing gas flow merge region 32A, and will not be further described.

The recessed portion 38 is formed on the surface of the cathode separator 3 so as to be located in a turn portion on the 2nd side of the serpentine-shaped oxidizing gas passage region 102. This recessed portion 38 is formed into a substantially right triangular shape having a base 38a extending vertically and a pair of hypotenuses 38b and 38c having about 45-degree included angles with the base 38a when viewed from the surface of the cathode separator 3. The base 38a forms the outer end (side edge) of the turn portion of the oxidizing gas passage region 102, the upper hypotenuse 38b forms the boundary with the 1st oxidizing gas flow splitting region 31A, and the lower hypotenuse 38c forms the boundary with the 2nd oxidizing gas flow splitting region 31B.

The base 38a is partially curved to form in intermediate locations a plurality of (eleven) protruding portions 58d (outer end protruding portions) protruding toward the recessed portion 38 and base portions 58e interposed between the protruding portions 38d. Each of the oxidizing gas passage grooves 35 of the 1st oxidizing gas flow splitting region 31A is connected to the recessed portion 38 at the upper hypotenuse 38b, while each of the oxidizing gas passage grooves 35 of the 2nd oxidizing gas flow splitting region 31B is connected to the recessed portion 38 at the lower hypotenuse 38c. Herein the recessed portion 38 is formed to have a depth equal to that of the oxidizing gas passage grooves 35.

As shown in FIGS. 8 and 9, a plurality of cylindrical protrusions 37 are formed at a uniform pitch P4 on the extended lines of the convex portions 36 (except for the uppermost and lowermost ones of the convex portions 36) of the 1st and 2nd oxidizing gas sub-split passages 31A and 31B. The pitch P4 herein is the same as the pitch P3 of the convex portions 36 of each of the oxidizing gas flow splitting regions 31A and 31B. Moreover, as shown in FIG. 8, all the cylindrical protrusions 37 have a uniform height (level difference) D4 and the same shape.

By arranging the plurality of cylindrical protrusions 37 on the extended lines of the convex portions 36, suitably, the reaction gas flows from each oxidizing gas passage groove 35 in the 1st oxidizing gas flow splitting region 31A into the 1st oxidizing gas merge region 32A such that the reaction gas is guided so as to be dispersed substantially uniformly in the gaps (grooves) between the plurality of cylindrical protrusions 37, and thereafter the flow of the reaction gas moving downward by its own weight is suitably disordered by the cylindrical protrusions 37 forming a subsequent row. In the present embodiment, as shown in FIG. 9, the cylindrical protrusions 37 are arranged so that their centers conform to the direction of the extended lines of the convex portions 36.

The plurality of cylindrical protrusions 37 are arranged regularly in so-called zigzag shape as shown in FIG. 9.

To be specific, the plurality of the cylindrical protrusions 37 are so formed to be lined up at a uniform pitch in a direction in which the base 38a extends (i.e., vertical direction) and be lined up at a uniform pitch in a direction perpendicular to the direction in which the base 38a extends (i.e., horizontal direction). Hereinbelow, a continuum of the cylindrical protrusions 37 in the vertical direction (including the case of only one protrusion) is referred to as a “column,” and the continuum of the cylindrical protrusions 37 in the horizontal direction is referred to as a “row” (including the case of only one protrusion). Accordingly, the plurality of the cylindrical protrusions 37 are formed to have 16 columns (respectively referred to as the 1st column through the 16th column in that order from the vertex of the recessed portion 38) and 21 rows (respectively referred to as the 1st row through the 21st row in that order from the top). Each column comprises the cylindrical protrusions 37 which constitute every other row. Conversely, each row comprises the cylindrical protrusions 37 which constitute every other column. In other words, in adjacent columns, the positions of the cylindrical protrusions 37 in the direction in which the columns extend (vertical direction) deviate by half a pitch from each other. Likewise, in adjacent rows, the positions of the cylindrical protrusions 37 in the direction in which the rows extend (horizontal direction) deviate by half a pitch from each other. In each row, the cylindrical protrusions 37 are disposed at a pitch which is twice as long as its diameter thereof (i.e., spaced with a gap equal to its diameter), and in each column, the cylindrical protrusions 37 are disposed at a pitch which is four times as long as its diameter (i.e., spaced with a gap equal to three times as large as its diameter).

Thus, the lines connecting the centers of the cylindrical protrusions 37 in the adjacent columns with each other, or the lines connecting the centers of the cylindrical protrusions 37 in the adjacent rows with each other, extend in such a manner as to be bent in a V-shape in the vertical direction along the base 38a, or in a horizontal direction on the extended line of the convex portions 36.

For example, the lines connecting the centers of the cylindrical protrusions 37 in adjacent columns with each other in the vertical direction (see the dotted lines in FIG. 9) extend in zigzag shape so as to be bent at an obtuse angle (θ₁ shown in FIG. 9 being about 127 degrees) plural times, while the lines connecting the centers of the cylindrical protrusions 37 in adjacent rows with each other in the horizontal direction (see the dotted lines in FIG. 9) extend in zigzag shape so as to be bent at an acute angle (θ₂ shown in FIG. 9 being about 53 degrees) plural times.

As should be understood from the illustration in FIG. 9 and the foregoing description, the zigzag array of the protrusions in the present specification is an array pattern of the cylindrical protrusions 37 in which the columns extending vertically in parallel are constituted by the cylindrical protrusions 37 which constitute every other row (in other words, an array pattern of the cylindrical protrusions 37 in which the rows extending horizontally in parallel are constituted by the cylindrical protrusions 37 which constitute every other column). For example, the zigzag array of the cylindrical protrusions 37 in the present specification refers to, regarding the arrangement of the cylindrical protrusions 37 in the vertical direction, a pattern in which the cylindrical protrusions 37 are arrayed in zigzag shape between the columns adjacent to each other to enable the gas-liquid two-phase flow flowing through the gaps between the cylindrical protrusions 37 in a certain row downwardly to contact the cylindrical protrusions 37 in a subsequent row, in order to avoid that this gas-liquid two-phase flow passes through in the subsequent row without being disturbed at all.

Accordingly, the array pattern as shown in the present embodiment (FIG. 5) in which the cylindrical protrusions 37 in the adjacent columns deviate by half the pitch of the cylindrical protrusions 37 in the same rows is a typical example of the zigzag array of the protrusions, but the zigzag array is not limited to this. For example, the gap between the cylindrical protrusions in adjacent columns may be ¼ the pitch of the cylindrical protrusions in the same rows, as will be described later in modified example 5. That is, the array patterns of the cylindrical protrusions in which “the gap between the cylindrical protrusions in the adjacent columns<half the pitch of the cylindrical protrusions in the same rows” or “the gap between the cylindrical protrusions in the adjacent columns>half the pitch of the cylindrical protrusions in the same rows” are also included in the zigzag array of the protrusions in the present specification, so long as the flooding is effectively suppressed.

As shown in FIGS. 8 and 9, one cylindrical protrusion 37 in the uppermost row (1st row) and one cylindrical protrusion 37 in the lowermost row (21st row) are each located between the convex portion 36 and the base portion 38e in such a manner that the cylindrical protrusion 37 in the uppermost row is spaced a distance L4 apart from the convex portion 36 in the 2nd row and from the base portion 38e and the cylindrical protrusion 37 in the lowermost row is spaced the distance L4 apart from the convex portion 36 in the 22nd row and from the base portion 38e.

Two cylindrical protrusions 37 in the 2nd row and two cylindrical protrusions 37 in the 20th row are arranged in the horizontal direction and are located to be spaced the distance L3 apart from each other between the convex portion 36 and the base portion 38e in such a manner that the cylindrical protrusions 37 in the 2nd row are spaced the distance L4 apart from the convex portion 36 in the 3rd row and from the base portion 38e and the cylindrical protrusions 37 in the 20th row are spaced the distance L4 apart from the convex portion 36 in the 21st row and from the base portion 38e.

Three cylindrical protrusions 37 in the 3rd row and three cylindrical protrusions 37 in the 19th row are arranged in the horizontal direction and are located to be spaced the distance L3 apart from each other between the convex portion 36 and the protruding portion 38d in such a manner that the cylindrical protrusions 37 in the 3rd row are spaced the distance L4 apart from the convex portion 36 in the 4th row and from the protruding portion 38d and the cylindrical protrusions 37 in the 19th row are spaced the distance L4 apart from the convex portion 36 in the 20th row and from the protruding portion 38d.

Four cylindrical protrusions 37 in the 4th row and four cylindrical protrusions 37 in the 18th row are arranged in the horizontal direction and are located to be spaced the distance L3 apart from each other between the convex portion 36 and the base portion 38e in such a manner that the cylindrical protrusions 37 in the 4th row are spaced the distance L4 apart from the convex portion 36 in the 5th row and from the base portion 38e and the cylindrical protrusions 37 in the 18th row are spaced the distance L4 apart from the convex portion 36 in the 19th row and from the base portion 38e.

Five cylindrical protrusions 37 in the 5th row and five cylindrical protrusions 37 in the 17th row are arranged in the horizontal direction and are located to be spaced the distance L3 apart from each other between the convex portion 36 and from the base portion 38e in such a manner that the cylindrical protrusions 37 in the 5th row are spaced the distance L4 apart from the convex portion 36 in the 6th row and from the protruding portion 38d and the cylindrical protrusions 37 in the 17th row are spaced the distance L4 apart from the convex portion 36 in the 18th row and from the protruding portion 38d.

Six cylindrical protrusions 37 in the 6th row and six cylindrical protrusions 37 in the 16th row are arranged in the horizontal direction and are located to be spaced the distance L3 apart from each other between the convex portion 36 and from the base portion 38e in such a manner that the cylindrical protrusions 37 in the 6th row are spaced the distance L4 apart from the convex portion 36 in the 7th row and the base portion 38e and the cylindrical protrusions 37 in the 16th row are spaced the distance L4 apart from the convex portion 36 in the 17th row and from the base portion 38e.

Six cylindrical protrusions 37 in the 7th row and six cylindrical protrusions 37 in the 15th row are arranged in the horizontal direction and are located to be spaced the distance L3 apart from each other between the convex portion 36 and the protruding portion 38d in such a manner that the cylindrical protrusions 37 in the 7th row are spaced the distance L4 apart from the convex portion 36 in the 8th row and from the protruding portion 38d and the cylindrical protrusions 37 in the 15th row are spaced apart the distance L4 from the convex portion 36 in the 16th row and from the protruding portion 38d.

Seven cylindrical protrusions 37 in the 8th row and seven cylindrical protrusions 37 in the 14th row are arranged in the horizontal direction and are located to be spaced the distance L3 apart from each other between the convex portion 36 and the base portion 38e in such a manner that the cylindrical protrusions 37 in the 8th row are spaced the distance L4 apart from the convex portion 36 in the 9th row and from the base portion 38e and the cylindrical protrusions 37 in the 14th row are spaced the distance L4 apart from the convex portion 36 in the 15th row and from the base portion 38e.

Seven cylindrical protrusions 37 in the 9th row and seven cylindrical protrusions 37 in the 13th row are arranged in the horizontal direction and are located to be spaced the distance L3 apart from each other between the convex portion 36 and the protruding portion 38d in such a manner that the cylindrical protrusions 37 in the 9th row are spaced the distance L4 apart from the convex portion 36 in the 10th row and from the protruding portion 38d and the cylindrical protrusions 37 in the 13th row are spaced the distance L4 apart from the convex portion 36 in the 14th row and from the protruding portion 38d.

Eight cylindrical protrusions 37 in the 10th row and eight cylindrical protrusions 37 in the 12th row are arranged in the horizontal direction and are located to be spaced the distance L3 apart from each other between the convex portion 36 and the base portion 38e in such a manner that the cylindrical protrusions 37 in the 10th row are spaced the distance L4 apart from the convex portion 36 in the 11th row and from the base portion 38e and the cylindrical protrusions 37 in the 12th row are spaced the distance L4 apart from the convex portion 36 in the 13th row and from the base portion 38e.

Eight cylindrical protrusions 37 in the 11th row are arranged in the horizontal direction and are located to be spaced the distance L3 apart from each other between the convex portion 36 and the protruding portion 38d in such a manner that the cylindrical protrusions 37 in the 11th row are spaced the distance L4 apart from the convex portion 36 in the 12th row and from the protruding portion 38d.

The cylindrical protrusion 37 is not present between the convex portion 36 in the uppermost row (1st row) and the base portion 38e and between the convex portion 36 in the lowermost row (23rd row) and the base portion 38e. The convex portions 36 and the base portions 38e are located to be spaced the distance L4 apart from each other.

It has been found through the later-described fluid analysis simulation that the flow rate of the reaction gas is higher in the gaps between the cylindrical protrusion 37 and the convex portion 36, between the cylindrical protrusion 37 and the protruding portion 38d, and between the convex portion 36 and the protruding portion 38d than in the gap between the cylindrical protrusions 37. For this reason, the distance L4 between the cylindrical protrusion 37 and the convex portion 36, between the cylindrical protrusion 37 and the protruding portion 38d, and between the convex portion 36 and the protruding portion 38d is made narrower than the distance L3 between the cylindrical protrusions 37, as shown in FIGS. 8 and 9.

A specific design guideline for the distances L3 and L4 is as follows. The distance L3 and the distance L4 are set in such a manner that the product of the distance L3 and the flow rate of the reaction gas flowing across the distance L3 assuming that the distance L3 and the distance L4 are equal will substantially match the product of the distance L4 and the flow rate of the reaction gas flowing across the distance L4 assuming that the distance L3 and the distance L4 are equal. By making the distance L4 between the cylindrical protrusion 37 and the convex portion 36, between the cylindrical protrusion 37 and the protruding portion 38d, and between the convex portion 36 and the protruding portion 38d narrower than the distance L3 between the cylindrical protrusions 37, uniformization of the flow rate distribution of the oxidizing gas and the condensed water flowing in the recessed portion 38 over the entire surface can be adjusted by the passage resistance exhibited by the distance L4 appropriately.

In the manner described above, the cylindrical protrusions 37 serve as the gas flow disturbing portions for promoting mixing of the oxidizing gas and also serve as the support portions (ribs) for the electrode portion 5 of the MEA 1.

The configurations of the 2nd, 3rd and 4th oxidizing gas flow merge regions 32B, 32C, and 32D are the same as the configuration described here, and therefore the descriptions of the configurations thereof will be omitted.

The above described cathode separator 3 (particularly the configuration of the oxidizing gas flow merge regions) makes it possible to obtain the following advantages regarding promotion of mixing of the oxidizing gas, suppressing flooding due to excess condensed water, and oxidizing gas pressure uniformization between a plurality of oxidizing gas passage grooves 35.

Firstly, since the 1st, 2nd, 3rd, and 4th oxidizing gas flow merge regions 32A, 32B, 32C, and 32D are formed so as to have oblique linear boundaries with the oxidizing gas flow splitting regions, and the distances L3 and L4 between the cylindrical protrusion 37 and the convex portion 36, the protruding portion 38d, and the base portion 38e are properly set, and the oxidizing gas flows uniformly in the 1st oxidizing gas flow merge region 32A, for example, and the oxidizing gas distribution performance for the oxidizing gas passage grooves 35 located downstream thereof (the oxidizing gas passage grooves 35 of the 2nd oxidizing gas flow splitting region 21B) does not degrade, making it possible to keep the uniformity of oxidizing gas flow rate in a good condition (in a condition in which variation of the gas flow rate can be reduced sufficiently).

Secondly, since the 1st, 2nd, 3rd, and 4th oxidizing gas flow merge regions 32A, 32B, 32C, and 34D are defined in a shape protruding in an arc shape as described above, more specifically, in a substantially triangular shape, the oxidizing gas can be allowed to flow substantially over the entire area of the recessed portion so that it can be sent out to the corners of the recessed portion 38 appropriately. Therefore, the oxidizing gas distribution performance for the oxidizing gas passage grooves 35 located downstream of the recessed portion 38 does not degrade, and thus the uniformity in the oxidizing gas flow rate can be improved (i.e., variation in the gas flow rate can be reduced sufficiently).

Thirdly, the flow of the oxidizing gas and the condensed water flowing from the oxidizing gas passage grooves 35 of the oxidizing gas flow merge region set 31 into the oxidizing gas flow merge region set 32 is disturbed by the plurality of cylindrical protrusions 37 arranged in zigzag shape in the recessed portion 38. Thereby, the mixing of the oxidizing gas and condensed water between the oxidizing gas passage grooves 35 can be promoted, and the flooding due to the excess condensed water within the passage grooves can be suppressed appropriately. The effect of suppressing the flooding is supported by a calculation result of a fluid simulation described later.

Fourthly, since the base 38a of the recessed portion 38 is curved to form in intermediate positions the plurality of (nine) protruding portions 38d (outer end protruding portions) protruding toward the recessed portion 38 and the base portions 38e each sandwiched between these protruding portions 38d, a part of the oxidizing gas and the condensed water flowing from each oxidizing gas passage groove 35 of the oxidizing gas flow splitting region set 32 into the oxidizing gas flow merge region set 32, which part flows in the vicinity of the base (outer end) 38a, is disturbed in flow. This makes it possible to promote mixing the oxidizing gas and the condensed water between the oxidizing gas passage grooves 35, and to thus appropriately suppress the flooding due to the excess condensed water within the passage grooves. The effect of suppressing the flooding is supported by a calculation result of a fluid simulation described later.

Fifthly, all the oxidizing gas passage grooves 35 of the oxidizing gas flow splitting region set 31 are gathered in the oxidizing gas flow merge region set 32, and here, pressure uniformization of the oxidizing gas is achieved.

In the present embodiment, the number of grooves of the oxidizing gas passage grooves 35 in the oxidizing gas flow splitting regions 31A, 31B, 31C, 31D, and 31E is set equal (eleven rows). In an alternative example of the present embodiment, it becomes possible to finely adjust the numbers of grooves of the oxidizing gas passage grooves 35 in the oxidizing gas flow merge regions 32A, 32B, 32C, and 32D which serve as the relay parts which can change the number of grooves as desired. For example, the number of grooves of the oxidizing gas passage grooves of the oxidizing gas flow splitting regions located upstream of the oxidizing gas flow merge regions 32A, 32B, 32C and 32D may be one row smaller than the number of grooves of the oxidizing gas passage grooves in the oxidizing gas flow splitting regions located downstream of the oxidizing gas flow merge regions 32A, 32B, 32C and 32D. This suitably enables fine adjustment of the flow rate of the oxidizing gas, considering an oxidizing gas consumption amount of the oxidizing gas flowing in the oxidizing gas passage groove.

Next, an example of the operation of the fuel cell 10 according to the present embodiment will be described.

The electrode portion 5 which is in contact with the anode separator 2 is, as shown in FIG. 3, exposed to the fuel gas, at the openings of the upper ends of the plurality of fuel gas passage grooves 25 (concave portions 25) while suppressing the flooding due to the excess condensed water.

The electrode portion 5 which is in contact with the cathode separator 3 is, as shown in FIG. 7, exposed to the oxidizing gas, at the openings of the upper ends of the plurality of oxidizing gas passage grooves 35 (concave portions 35) while suppressing the flooding due to the excess condensed water.

For this reason, the fuel gas diffuses uniformly into the electrode portion 5 over the entire surface area of the electrode portion 5 while the fuel gas is flowing through the fuel gas passage region 101, and the oxidizing gas diffuses uniformly into the electrode portion 5 over the entire surface area of the electrode portion 5 while the oxidizing gas is flowing through the oxidizing gas passage region 102. As a result, the power generating operation by the fuel cell 10 can be carried out uniformly over the entire surface of the electrode portion 5.

Next, the inventors of the present application have verified by modeling a region in the vicinity of the flow merge region of the separator (hereinafter referred to as a passage turn adjacent portion) which flows the gas-liquid two-phase flow containing condensed water and reaction gas on a computer and by utilizing the thermo-fluid simulation technology detailed below, the flooding suppressing effect of the cylindrical protrusions 38 and the protruding portions 38d in the passage turn adjacent portion described in the present embodiment.

### <Analysis Simulator>

The present fluid simulation has been conducted using a general-purpose thermo-fluid dynamics analysis software program “FLUENT” (registered trademark) made by Fluent Inc. in the U.S., Version: 6.2.16.

The FLUENT (registered trademark) uses a discretization technique called the finite volume method. It divides a region which is to be analyzed into small spaces made of predetermined elements, solves a general equation governing a fluid flow based on the balance of the fluid exchanged between the small elements, and executes repetitive computation with the computer until the result converges.

### <Analysis Model>

Herein the modeling of passage turn adjacent portions of a separator includes an analysis model which employs, as shown in FIG. 5, an analysis model which employs the cylindrical protrusions in a zigzag array and the protruding portions on the base in the recessed portion (which is referred to as a “present embodiment analysis model”), and an analysis model which employs the cylindrical protrusions in a grid array (which is hereinafter referred to as a “comparative example analysis model”).

The configurations (i.e., shapes) of the present embodiment analysis model have been already described with reference to FIG. 5, and therefore the descriptions of the configurations will be omitted here.

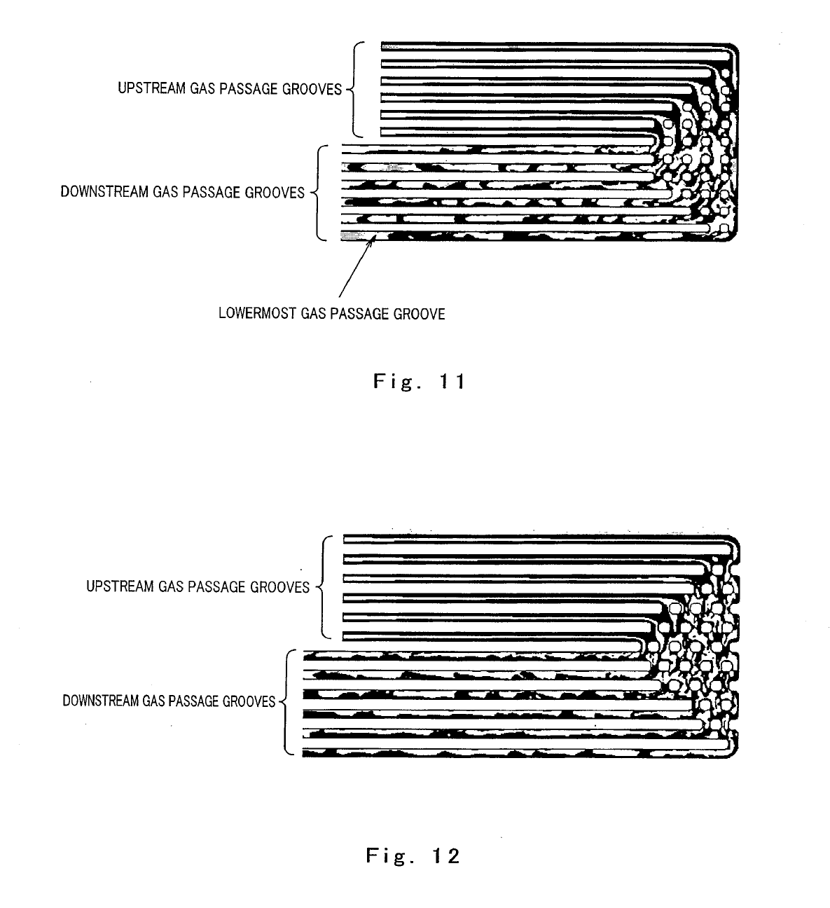

As shown in FIG. 10, in the comparative example analysis model, a recessed portion 48 connected to gas passage grooves 45 (concave portions 45) is defined in a substantially triangular shape by a base 48a extending linearly in the vertical direction, and a pair of hypotenuses 48b and 48c. The plurality of island-form cylindrical protrusions 47 extending vertically on the base of the recessed portion 48 are arranged in an orthogonal grid shape in the recessed portion so that the centers of the cylindrical protrusions 47 coincides with each other in the direction in which the base 48a extends (vertical direction) and the direction perpendicular to the direction in which the base 48a extends (horizontal direction on the extended line of the convex portion 46). Furthermore, a distance between the cylindrical protrusion 47 and the convex portion 46, a distance between the cylindrical protrusion 47 and the base 48a, a distance between the cylindrical protrusions 47, and a distance between the convex portion 46 and the base 48a are set equal.

As analysis conditions (boundary condition, etc) in the above analysis models, various data in a rated operation of a fuel cell are basically employed.

For example, the gas-liquid two-phase flow (flow rate: 2.34 m/s, for example) in which the mixing ratio of the condensed water and the reaction gas is 1:1 is employed as an influent condition, a surface tension (7.3×10²N/m) is employed as water's physical property data, and a contact angle (0.1 degree, for example) is employed as the physical property or surface data of condensed water and separator.

In addition, a pressure (927.33 Pa, for example) and a pressure loss coefficient (4.546×10⁹/m² for example; note that the grooves on the downstream side are extended 40 mm longer than those on the upstream side, because of the passage resistance increase on the downstream side) are adopted as the effluent conditions of the gas-liquid two-phase flow.

Moreover, the wall surface is regarded as non-slip as to the flow rate of the gas-liquid two-phase flow.

### <Analysis Results>

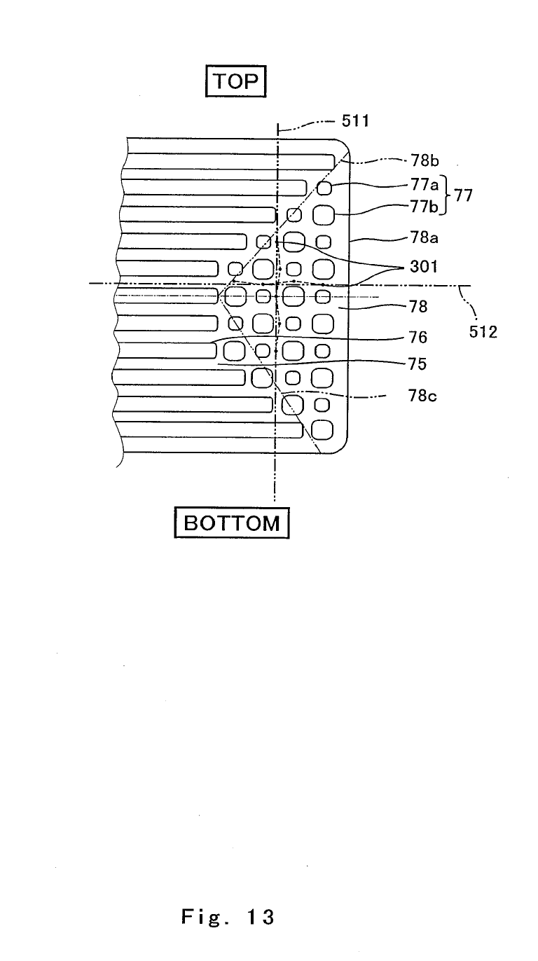

FIGS. 11 and 12 are views showing examples of the analysis results which are output on the computer based on the flow data of the elements according to the above-described analysis models.

Specifically, FIG. 11 depicts the distribution of condensed water (black) and the reaction gas (uncolored) at the time when the gas-liquid two-phase flow reached a steady state in the comparative example analysis model, and FIG. 12 depicts the same kind of view for the present embodiment analysis model.

It has been confirmed that the protrusions arranged vertically in an orthogonal grid shape in the recessed portion, according to the comparative example analysis model (FIG. 11), make it possible to mix the flow of the condensed water sent out from the gas passage grooves located upstream of the recessed portion, and achieve a certain degree of dispersion of the condensed water into the gas passage grooves located downstream of the recessed portion. However, the simulation result shown in FIG. 11 visualizes that a relatively large amount of condensed water is flowing into a part of the gas passage grooves located downstream of the recessed portion, for example, into the lowermost row of the gas passage groove located downstream of the recessed portion, and as a consequence, the condensed water is beginning to clog the groove.

In contrast, it has been confirmed that the protrusions arranged vertically in zigzag shape and the base protruding portions in the recessed portion according to the present embodiment analysis model (FIG. 12) make it possible to sufficiently mix the flow of the condensed water sent out from the gas passage grooves located upstream of the recessed portion, and achieve very good dispersion of the condensed water into the gas passage grooves located downstream of the recessed portion. The simulation result shown in FIG. 12 visualizes that, for example, the condensed water is distributed and allowed to flow substantially uniformly over all the gas passage grooves located downstream of the recessed portion.

It has been verified from the simulation results described above that a separator (cathode separator or anode separator) employing the embodiment analysis model can appropriately sufficiently prevent the flooding due to excess condensed water in the gas passage grooves located downstream of the recessed portion.

The configuration of the passage turn adjacent portion according to the present embodiment has an optimal design for uniform dispersion of the condensed water in the gas passage grooves, which employs both cylindrical protrusions formed in a zigzag array on the bottom face of the recessed portion and protruding portions formed on the base of the recessed portion. Nonetheless, it may be presumed that even the recessed portion using only one of these structures can sufficiently uniformly disperse the condensed water within the gas passage grooves, in contrast to the comparative analysis model. In other words, it may be considered that the separator using either the structure of the cylindrical protrusions in the zigzag array or the protruding portions on the base of the recessed portion can suppress the flooding due to excess condensed water within the gas passage grooves, in contrast to the separator according to the comparative example analysis model (FIG. 10).

### <Modified Examples of Passage Turn Adjacent Portion (Recessed Portion)>

The foregoing description has been given of examples of the protrusion arrangement (hereinafter referred to as zigzag array) in the passage turn adjacent portion (recessed portion) as represented by the embodiment (FIGS. 5 and 9), in which a plurality of cylindrical protrusions 27 and 37 are arranged regularly in zigzag shape. Also, in the comparative example (FIG. 10), the foregoing description has been given of example of the protrusion arrangement (hereinafter referred to as grid array) in the passage turn adjacent portion (recessed portion) in which a plurality of cylindrical protrusions 47 are arranged in orthogonal grid shape.

Hereinbelow, modified examples 1, 2, 3, and 4 of the passage turn adjacent portions, in which the shape or the like of the cylindrical protrusions 47 in the grid array is partially changed so that the flooding can be suppressed in contrast to the comparative example, will be described. In addition, modified example 5 of the passage turn adjacent portion, in which the gap between the protrusions in adjacent columns in the zigzag array is made smaller than the gap shown in the embodiment (FIGS. 5 and 9) will be described.

It should be noted that although the following modified examples 1, 2, 3, 4, and 5 describe the anode separator 2 as an example, the same applies to the cathode separator 3.

### Modified Example 1

FIG. 13 is a view of the configuration of a passage turn adjacent portion, viewed in plan, according to modified example 1.

Referring to FIG. 13, a recessed portion 78 connected to fuel gas passage grooves 75 (concave portions 75) is defined in a substantially triangular shape by a base 78a extending in a vertical direction, as an outer end of the passage turn adjacent portion, and a pair of hypotenuses 78b and 78c, as the boundaries with the fuel gas passage grooves 75 on both upstream and downstream sides. A plurality of protrusions 77 in an island form which vertically extend from the bottom face of the recessed portion 78 are disposed and arranged in an orthogonal grid shape so that their centers conform to each other in a direction in which the base 78a extends (vertical direction) and the direction (horizontal direction on the extended lines of the convex portions 76) perpendicular to the direction in which the base 78a extends.

The protrusions 77 are formed to have one shape selected from a substantially cylindrical shape, a substantially triangular prism shape, and a substantially quadrangular prism shape. In the present modified example, 14 pieces, in total, of 1st protrusions 77a formed in a substantially cylindrical or a substantially quadrangular prism shape, and 14 pieces, in total, of 2nd protrusions 77b formed in a substantially cylindrical shape or a substantially quadrangular prism shape such as to have larger widths in the vertical direction and the horizontal direction than the 1st protrusions 77a, are disposed alternately.

Specifically, as shown in FIG. 13, the 1st protrusions 77a and the 2nd protrusions 77b which have different width dimensions in the vertical and horizontal directions from each other are disposed alternately in such a manner that the shapes of the protrusions 77 which are vertically and horizontally adjacent to each other become different from each other.

According to the arrangement configuration of the protrusions 77, the 1st protrusions 77a having a smaller width dimension in the vertical direction and the horizontal direction and the 2nd protrusions 77b having a larger width dimension in the vertical direction and the horizontal direction are disposed alternately in the horizontal direction and the vertical direction. Thereby, the lines connecting the centers 301 in the gaps between the 1st protrusions 77a and the 2nd protrusions 77b in the vertical direction or the horizontal direction (one example of such a line is shown in FIG. 13 by the dotted line connecting the centers 301) curve in zigzag shape in a longitudinal direction of the gaps (grid-shaped grooves between the 1st protrusions 77a and the 2nd protrusions 77b) through which gas-liquid two-phase flow of the fuel gas and condensed water flows. In other words, when a virtual line (virtual straight line) 511 is drawn to pass through the center 301 in a gap between a pair of protrusions 77 arranged adjacent each other to form one row and extend in parallel to the direction in which the base 78a extends, the center in the gap between a pair of protrusions 77 which are adjacent the former pair of protrusions 77 in the direction in which the base 78a extends deviates from the virtual line 511 in the direction perpendicular to the direction in which the base 78a extends. Also, when a virtual line (virtual straight line) 512 is drawn to pass through the center 301 in a gap between a pair of protrusions 77 arranged adjacent each other to form one column and extend in the direction perpendicular to the direction in which the base 78a extends, the center in the gap between a pair of protrusions 77 which are adjacent the former pair of protrusions 77 in the direction perpendicular to the direction in which the base 78a extends deviates from the virtual line 512 in the direction in which the base 78a extends.

In this structure, when the gas-liquid two-phase flow flows through the gaps in the horizontal direction and the vertical direction in the recessed portion 78, the flow of the gas-liquid two-phase flow is disturbed and bent, and thus the gas-liquid two-phase flow is hindered from passing through the gaps easily.

For this reason, mixing of the fuel gas is further promoted by such a bent flow of the fuel gas, in contrast to the comparative example. Moreover, the flooding due to the excess condensed water within the fuel gas passage grooves 75 on the downstream side is further suppressed because of the bent flow of the condensed water, in contrast to the comparative example. Furthermore, by setting the numbers and locations of the 1st protrusions 77a and the 2nd protrusions 77b appropriately for each of the columns and rows, the fuel gas passage resistance within the recessed portion 78 can be adjusted to make the fuel gas flow rate uniform.

### Modified Example 2

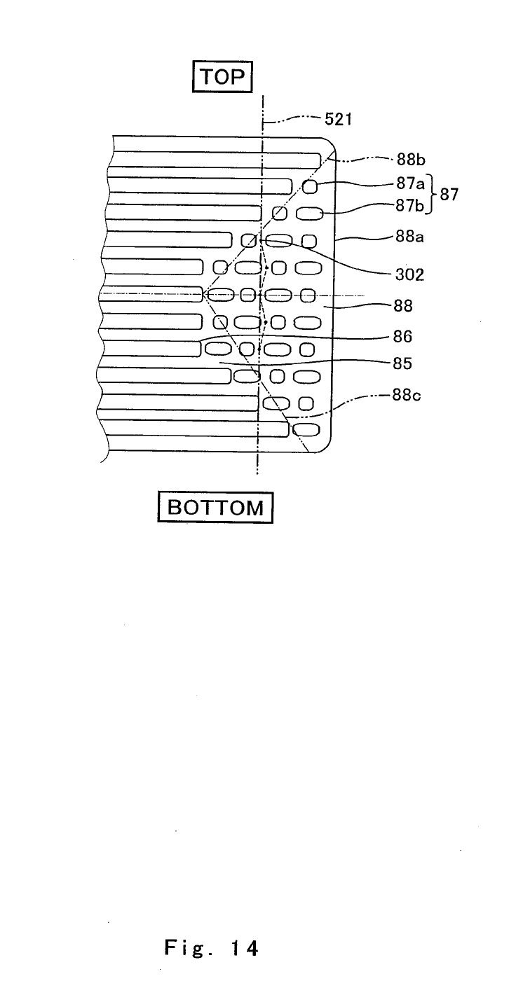

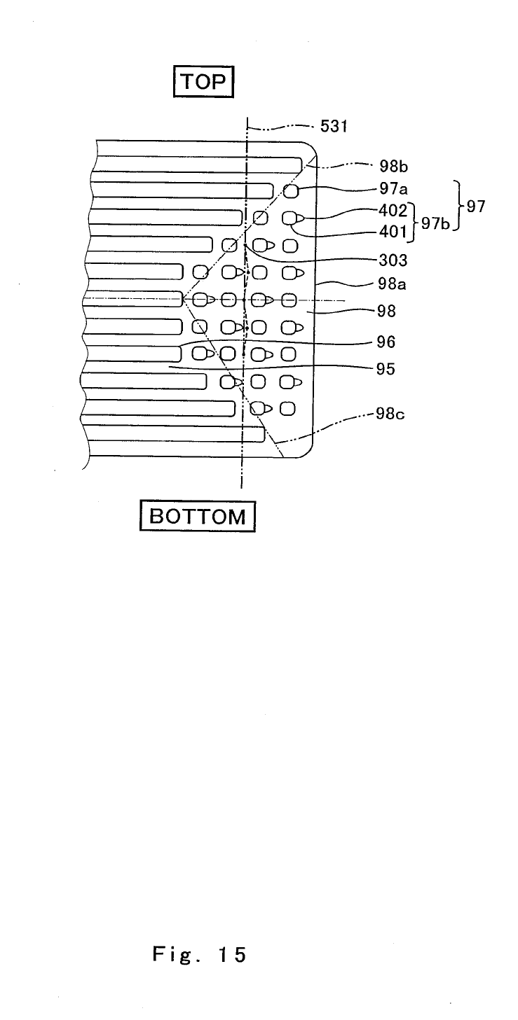

FIG. 14 is a view of the configuration of a passage turn adjacent portion, viewed in plan, according to modified example 2.

Referring to FIG. 14, a recessed portion 88 connected to fuel gas passage grooves 85 (concave portions 85) is defined in a substantially triangular shape by a base 88a extending in a vertical direction, as an outer end of the passage turn adjacent portion, and a pair of hypotenuses 88b and 88c, as the boundaries with the fuel gas passage grooves 85 on both upstream and downstream sides. A plurality of protrusions 87 in an island form which vertically extend from the bottom face of the recessed portion 88 are disposed and arranged in an orthogonal grid shape so that their centers conform to each other in a direction in which the base 88a extends (vertical direction) and in the direction (horizontal direction on the extended lines of the convex portions 86) perpendicular to the direction in which the base 88a extends.

The protrusions 87 are formed to have one shape selected from a substantially cylindrical shape, a substantially triangular prism shape, and a substantially quadrangular prism shape. In the present modified example, 14 pieces, in total, of 1st protrusions 87a formed in a substantially cylindrical or a substantially quadrangular prism shape, and 14 pieces, in total, of 2nd protrusions 87b formed in a substantially cylindrical shape (an elliptic cylinder shape herein) so as to have a larger width dimension in a horizontal direction than the 1st protrusions 87a, are disposed alternately.

Specifically, as shown in FIG. 14, the 1st protrusions 87a and the 2nd protrusions 87b which have different width dimensions in the horizontal direction from each other are disposed alternately in such a manner that the shapes of the protrusions 87 which are vertically and horizontally adjacent to each other become different from each other.

According to the arrangement configuration of the protrusions 87, the 1st protrusions 87a having a smaller width dimension in the horizontal direction and the 2nd protrusions 87b having a larger width dimension (length of the longitudinal axis) in the horizontal direction are disposed alternately in the horizontal direction and the vertical direction. Thereby, the lines connecting the centers 302 in the gaps between the 1st protrusions 87a and the 2nd protrusions 87b in the vertical direction (one example of such a line is shown in FIG. 14 by the dotted line connecting the centers 302) curve in zigzag shape in a longitudinal direction of the gaps (grid-shaped grooves between the first protrusions 87a and the second protrusions 87b) through which gas-liquid two-phase flow of the fuel gas and condensed water flows. In other words, when a virtual line (virtual straight line) 521 is drawn to pass through the center 302 in the gap between a pair of protrusions 87 arranged adjacent each other to form one row and extend in parallel to the direction in which the base 88a extends, the center in the gap between a pair of protrusions 87 which are adjacent the former pair of protrusions 87 in the direction in which the base 88a extends deviates from the virtual line 521 in the direction perpendicular to the direction in which the base 88a extends.

In this structure, when the gas-liquid two-phase flow flows through the gaps in the vertical direction in the recessed portion 88, the flow of the gas-liquid two-phase flow is bent and disturbed, and the gas-liquid two-phase flow is hindered from passing through the gaps easily.

For this reason, mixing of the fuel gas is further promoted by such a bent flow of the fuel gas, in contrast to the comparative example. Moreover, the flooding due to the excess condensed water in the fuel gas passage grooves 85 on the downstream side is further suppressed because of the bent flow of the condensed water, in contrast to the comparative example. Furthermore, by setting the numbers and locations of the 1st protrusions 87a and the 2nd protrusions 87b appropriately for each of the columns, the fuel gas passage resistance within the recessed portion 88 can be adjusted to make the fuel gas flow rate uniform.

### Modified Example 3

FIG. 15 is a view of the configuration of a passage turn adjacent portion, viewed in plan, according to modified example 3.

Referring to FIG. 15, a recessed portion 98 connected to fuel gas passage grooves 95 (concave portions 95) is defined in a substantially triangular shape by a base 98a extending in a vertical direction, as an outer end of the passage turn adjacent portion, and a pair of hypotenuses 98b and 98c, as the boundaries with the fuel gas passage grooves 95 on both upstream and downstream sides. A plurality of protrusions 97 in an island form which vertically extend from the bottom face of the recessed portion 98 are disposed and arranged in an orthogonal grid shape so that their centers conform to each other in a direction in which the base 98a extends (vertical direction) and in the direction (horizontal direction on the extended lines of the convex portions 96) perpendicular to the direction in which the base 98a extends.

The protrusions 97 are formed to have one shape selected from a substantially cylindrical shape, a substantially triangular prism shape, and a substantially quadrangular prism shape. In the present modified example, 14 pieces, in total, of 1st protrusions 97a formed in a substantially cylindrical or a substantially quadrangular prism shape, and 14 pieces, in total, of 2nd protrusions 97b, each of which has a base portion 401 having the same shape as the 1st protrusion 97a and a projecting portion 402 protruding from a part of a side face of the base portion 401 in the rightward direction (the direction toward the base 98a) and has a larger width dimension in the horizontal direction so as to be formed asymmetrically with respect to the horizontal direction, are disposed alternately.

Specifically, as shown in FIG. 15, the 1st protrusions 97a and the 2nd protrusions 97b which have different width dimensions in the horizontal direction from each other are disposed alternately in such a manner that the shapes of the protrusions 97 which are vertically and horizontally adjacent to each other become different from each other.

According to the arrangement configuration of the protrusions 97, the 1st protrusions 97a having a smaller width dimension in the horizontal direction and the 2nd protrusions 97b having a larger width dimension in the horizontal direction are disposed alternately in the horizontal direction and the vertical direction. Thereby, the lines connecting the centers 303 in the gaps between the 1st protrusions 97a and the 2nd protrusions 97b in the vertical direction (one example of such a line is shown in FIG. 51 by the dotted line connecting the centers 303) curve in zigzag shape in a longitudinal direction of the gaps (grid-shaped grooves between the first protrusions 97a and the second protrusions 97b) through which gas-liquid two-phase flow of the fuel gas and condensed water flows. In other words, when a virtual line (virtual straight line) 531 is drawn to pass through the center 303 in the gap between a pair of protrusions 97 arranged adjacent each other to form one row and extend in parallel to the direction in which the base 98a extends, the center in the gap between a pair of protrusions 97 which are adjacent the former pair of protrusions 77 in the direction in which the base 98a extends deviates from the virtual line 531 in the direction perpendicular to the direction in which the base 98a extends.

In this structure, when the gas-liquid two-phase flow flows through the gaps in the vertical direction in the recessed portion 98, the flow of the gas-liquid two-phase flow is bent and disturbed, and the gas-liquid two-phase flow is hindered from passing through the gaps easily.

For this reason, mixing of the fuel gas is further promoted by such a bent flow of the fuel gas, in contrast to the comparative example. Moreover, the flooding due to the excess condensed water in the fuel gas passage grooves 95 on the downstream side is further suppressed because of the bent flow of the condensed water, in contrast to the comparative example. Furthermore, by setting the numbers and locations of the 1st protrusions 97a and the 2nd protrusions 97b appropriately for each of the columns, the fuel gas passage resistance within the recessed portion 98 can be adjusted to make the fuel gas flow rate uniform.

### Modified Example 4

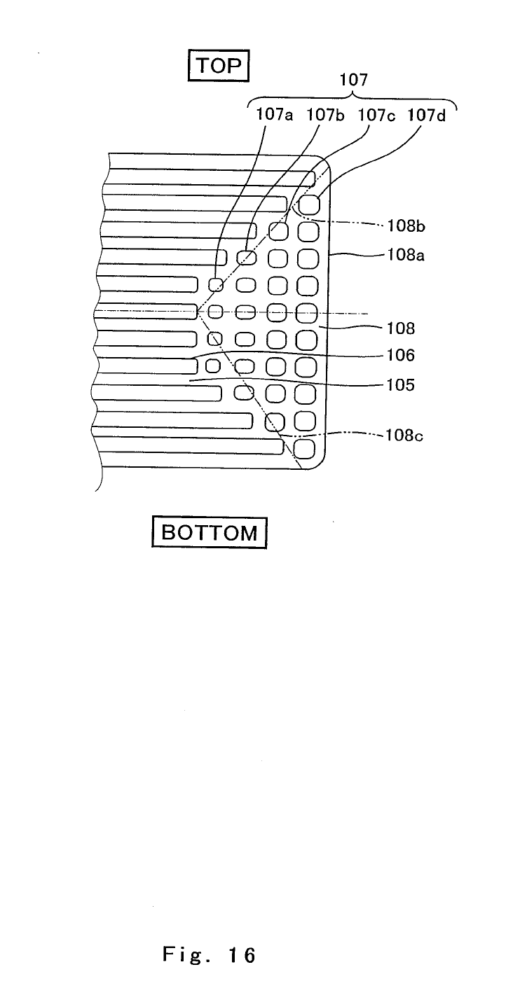

FIG. 16 is a view of the configuration of a passage turn adjacent portion, viewed in plan, according to modified example 4.

Referring to FIG. 16, a recessed portion 108 connected to fuel gas passage grooves 105 (concave portions 105) is defined in a substantially triangular shape by a base 108a extending in a vertical direction, as an outer end of the passage turn adjacent portion, and a pair of hypotenuses 108b and 108c, as the boundaries with the fuel gas passage grooves 105 on both upstream and downstream sides. A plurality of protrusions 107 in an island form which vertically extend from the bottom face of the recessed portion 108 are disposed and arranged in an orthogonal grid shape so that their centers conform to each other in a direction in which the base 108a extends (vertical direction) and in the direction (horizontal direction on the extended lines of the convex portions 106) perpendicular to the direction in which the base 108a extends.

The protrusions 107 are formed to have one shape selected from a substantially cylindrical shape, a substantially triangular prism shape, and a substantially quadrangular prism shape. In the present modified example, the protrusions 107 include: 4 pieces of 1st protrusions 107a which are formed in a substantially cylindrical shape or a substantially quadrangular prism shape and which constitute the 1st row; 6 pieces of 2nd protrusions 107b which are formed in a substantially cylindrical shape or a substantially quadrangular prism shape so as to have larger width dimensions in the vertical direction and the horizontal direction than the 1st protrusions 107a and which constitute the 2nd row; 8 pieces of 3rd protrusions 107c which are formed in a substantially cylindrical shape or a substantially quadrangular prism shape so as to have larger width dimensions in the vertical direction and the horizontal direction than the 2nd protrusions 107b and which constitute the 3rd row; and 10 pieces of 4th protrusions 107d which are formed in a substantially cylindrical shape or a substantially quadrangular prism shape such as to have larger width dimensions in the vertical direction and the horizontal direction than the 3rd protrusions 107c and which constitute the 4th row.

As shown in FIG. 16, the 1st protrusions 107a, the 2nd protrusions 107b, the 3rd protrusions 107c, and the 4th protrusions 107d, which have different width dimensions vertically and horizontally, are selected suitably and arranged so that the shapes of the protrusions 107 are larger in size in the direction from the right (the convex portion 106 side) to the left (the base 108a side) in the 2nd row through the 9th row.

For example, in a horizontal direction of the 4th row, a 1st protrusion 107a adjacent to a convex portion 106, a 2nd protrusion 107b adjacent to the 1st protrusion 107a, a 3rd protrusion 107c adjacent to the 2nd protrusion 107b, and a 4th protrusion 107d adjacent to the 3rd protrusion 107c and a base 108a are disposed to be lined up in that order.

The details of the arrangement configurations of the protrusions 107 except for those in the 4th row will be understood easily from the foregoing description and FIG. 16, and therefore the detailed descriptions thereof will be omitted here.

According to the arrangement configuration of such protrusions 107, the protrusions 107 having larger width dimensions in the vertical direction and the horizontal direction in the direction from the right to the left are disposed. Thereby, it is possible to appropriately change the distance between the protrusions 107, the distance between the protrusions 107 and the base 108a, and the distance between the protrusions 107 and the convex portions 106 according to the flow rate of the fuel gas.

For this reason, the flow rate distribution of the gas-liquid two-phase flow flowing through the recessed portions 108 can be made uniform appropriately over the entire surface by adjusting the fuel gas passage resistance exhibited by changing the distances.

### Modified Example 5

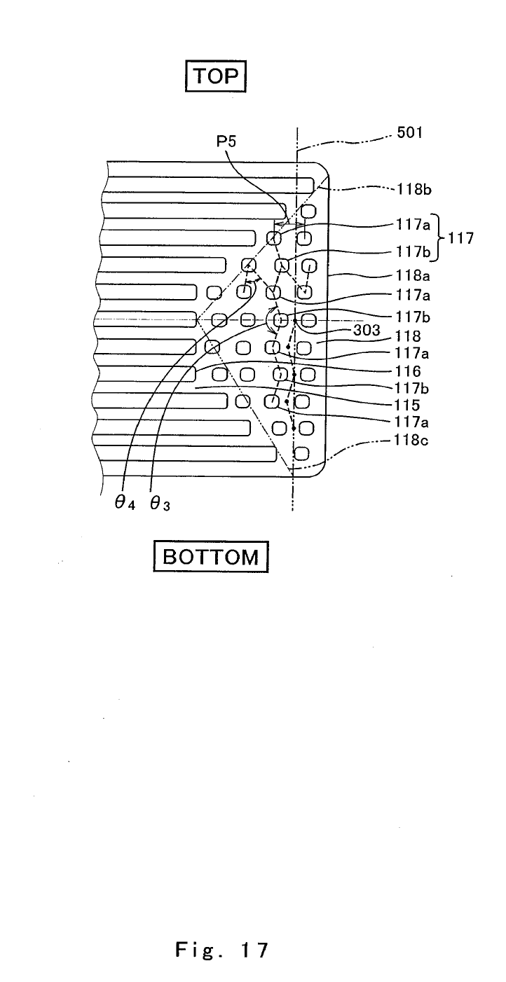

FIG. 17 is a view of the configuration of a passage turn adjacent portion, viewed in plan, according to modified example 5.

Referring to FIG. 17, a recessed portion 118 connected to fuel gas passage grooves 115 (concave portions 115) is defined in a substantially triangular shape by a base 118a extending linearly in a vertical direction, as an outer end of the passage turn adjacent portion, and a pair of hypotenuses 118b and 118c, as the boundaries with fuel gas passage grooves 115 on both upstream and downstream sides.

A plurality of protrusions 117 in a substantially cylinder shape or a subsequently quadrangular prism shape which vertically extend from the bottom face of the recessed portion 118 is so formed to be lined up at a uniform pitch in a direction in which the base 118a extends (i.e., vertical direction) and be lined up at a uniform pitch in a direction perpendicular to the direction in which the base 118a extends (i.e., horizontal direction). Hereinbelow, a continuum of the protrusions 117 in the vertical direction (including the case of only one protrusion) is referred to as a “column,” and the continuum of the protrusions 117 in the horizontal direction is referred to as a “row” (including the case of only one protrusion). Accordingly, the plurality of the protrusions 117 are formed to have 8 columns (respectively referred to as the 1st column through the 8th column in that order from the vertex U side of the recessed portion 118) and 10 rows (respectively referred to as the 1st row through the 9th row in that order from the top). Each column comprises the protrusions 117 which constitute every other row. Conversely, each row comprises the protrusions 117 which constitute every other column.

Thus, the lines connecting the protrusions 117 in the adjacent columns with each other, or the lines connecting the protrusions 117 in the adjacent rows with each other, extend so as to be bent in a V-shape in a vertical direction along the base 118a and in a horizontal direction on an extended line of the convex portions 116 and to be arrayed regularly in what is called zigzag shape. For example, the lines connecting the centers of protrusions 117 in adjacent columns with each other in the vertical direction (see the dotted lines in FIG. 17) extend in zigzag shape so as to be bent at an obtuse angle (θ₃ shown in FIG. 17 being about 152 degrees) plural times, while the lines connecting the centers of the protrusions 117 in adjacent rows with each other in the horizontal direction (see the dotted lines in FIG. 17) extend in zigzag shape so as to be bent at an acute angle (θ₄ shown in FIG. 17 being about 51 degrees) plural times.

In other words, when a virtual line (virtual straight line) 501 is drawn to pass through the center 303 in the gap between a pair of protrusions 177 arranged adjacent each other to form one row and extend in parallel to the direction in which the base 78a extends, the center in the gap between a pair of protrusions 177 which are adjacent the former pair of protrusions 177 in the direction in which the base 78a extends deviates from the virtual line 501 in the direction perpendicular to the direction in which the base 78a extends. The amount of deviation is equal to approximately ¼ pitch of the pitch P5 between the protrusions 177 in the same row. In other words, the protrusions 117a and the protrusions 117b are disposed alternately so as to be spaced apart from each other at about ¼ pitch horizontally and spaced apart by a width of the concave portion 115 vertically. When the amount of the deviation reaches half the pitch P2 of the protrusions 117, the protrusion array pattern according to the present modified example becomes the same kind of pattern as the arrangement shown in FIG. 5.

When the gas-liquid two-phase flow travels from above downward in the recessed portion 118, the protrusions 117 made to deviate in the above manner make it possible to hinder the gas-liquid two-phase flow from easily passing through the gaps between the protrusions 117 and to cause the gas-liquid two-phase flow to appropriately contact the protrusions 117 plural times to disturb the flow, and that to suppress the flooding due to the excess condensed water in the fuel gas passage grooves 115 located downstream of the recessed portion 118.

From the foregoing description, numerous improvements and other embodiments of the present invention will be readily apparent to those skilled in the art. Accordingly, the foregoing description is to be construed only as illustrative examples and as being presented for the purpose of suggesting the best mode for carrying out the invention to those skilled in the art. Various changes and modifications can be made substantially in the details of the structures and/or functions without departing from the scope and sprit of the invention.

### INDUSTRIAL APPLICABILITY

A fuel cell separator of the present invention is capable of suppressing flooding due to excess condensed water and is appl cable to polymer electrolyte fuel cells, for example.

1-18. (canceled)

19. A fuel cell separator,
wherein said fuel cell separator is formed in a plate shape and is provided on at least one main surface thereof with a reaction gas passage region through which a reaction gas flows, the reaction gas passage region being formed in a serpentine shape having a plurality of uniform-flow portions through which the reaction gas flows in one direction and one or more turn portions provided between the plurality of uniform-flow portions, the reaction gas flowing to turn in the turn portions; wherein
said reaction gas passage region comprises:
a plurality of flow splitting regions being formed so as to include at least said uniform-flow portions, and having a passage groove group for splitting a flow of the reaction gas; and
one or more flow splitting regions formed in at least one of said one or more turn portions, said regions having a recessed portion forming a space in which the reaction gas is mixed and a plurality of protrusions which vertically extend from a bottom face of said recessed portion and are arranged in an island form, being disposed between the passage groove group of an adjacent upstream flow splitting region and the passage groove group of an adjacent downstream flow splitting region of said plurality of flow splitting regions, and being configured to allow the reaction gas flowing from said passage groove group of said upstream flow splitting region to merge in said recessed portion and to allow the reaction gas which has been merged to split again and flow into said downstream flow splitting region; wherein
in said upstream flow splitting region and said downstream flow splitting region which are connected to said recessed portion of said flow merge region, the number of grooves of said passage groove group of said upstream flow splitting region is equal to the number of grooves of said passage groove group of said downstream flow splitting region;
said recessed portion of said flow merge region is, in said turn portion of said reaction gas passage region in which said recessed portion is formed, defined by an outer end of said turn portion and oblique boundaries between said recessed portion and a pair of said upstream passage groove group and said downstream passage groove group which are connected to said recessed portion; and
when viewed from a direction substantially normal to the main surface, the outer end is curved to form in intermediate locations outer end protruding portions protruding toward the recessed portion.

20. The fuel cell separator according to claim 19, wherein:
a convex-concave pattern comprising a plurality of concave portions having a uniform width, a uniform pitch, and a uniform level difference and a plurality of convex portions having a uniform width, a uniform pitch, and a uniform level difference in a direction crossing said passage groove group, is formed on a surface of said separator corresponding to said flow splitting region when viewed from the direction substantially normal to the main surface;
said concave portions are passage grooves of said passage groove group, and said convex portions are ribs for supporting an electrode portion making in contact with the main surface; and
said plurality of protrusions are disposed on extended lines of said ribs.

21. The fuel cell separator according to claim 20, wherein when said protrusions are formed in a substantially cylindrical shape, a first distance between said protrusion and said rib, between said protrusion and said outer end protruding portion, and between said rib and said outer end is smaller than a second distance between said protrusions.

22. The fuel cell separator according to claim 21, wherein the first distance and the second distance are set in such a manner that a product of the first distance and a flow rate of the reaction gas flowing across the first distance assuming that the first distance and the second distance are constant substantially matches a product of the second distance and a flow rate of the reaction gas flowing across the second distance assuming that the first distance and the second distance are constant.

23. The fuel cell separator according to claim 19, wherein said plurality of protrusions are disposed such that one or more of said protrusions form a plurality of columns lined up and spaced apart from each other with a gap in the direction in which the outer end extends and one or more of said protrusions form a plurality of rows lined up and spaced apart from each other with a gap in the direction perpendicular to the direction in which the outer end extends, and each of said columns is formed by protrusions forming every other row.

24. (canceled)
